(19) United States
(12) Patent Application Publication
(10) Pub. No.: US 2025/0282344 A1
(43) Pub. Date: Sep. 11, 2025

(54) ARTIFICIAL INTELLIGENCE MODELING TECHNIQUES FOR VISION-BASED HIGH-FIDELITY OCCUPANCY DETERMINATION AND ASSISTED PARKING APPLICATIONS

(71) Applicant: Tesla, Inc., Austin, TX (US)

(72) Inventors: Philip LEE, Austin, TX (US); Lawson FULTON, Austin, TX (US); Zicong MO, Austin, TX (US); Brandon LEUNG, Austin, TX (US); Xiuming ZHANG, Austin, TX (US); Pengfei Phil DUAN, Austin, TX (US); Ashok Kumar ELLUSWAMY, Austin, TX (US); Toan PHAM, Austin, TX (US); Igor SARCOVSCHI, Austin, TX (US); Evan SMALL, Austin, TX (US)

(73) Assignee: Tesla, Inc., Austin, TX (US)

(21) Appl. No.: 19/075,490

(22) Filed: Mar. 10, 2025

Related U.S. Application Data
(60) Provisional application No. 63/563,939, filed on Mar. 11, 2024.

(51) Int. Cl. B60W 30/06; B60K 35/28; G06V 20/58

(52) U.S. Cl. CPC B60W 30/06; B60K 35/28; G06V 20/586

(57) ABSTRACT

Disclosed herein are methods and system of implementing an AI-enabled high-fidelity occupancy network, allowing for the prediction of signed distances of voxelized objects in a 3D space surrounding an ego, thereby facilitating enhanced object shape refinement. Through the utilization of camera feeds only, an AI model accurately calculates signed distance values for various voxels in the 3D space. The predicted values can also be rendered by translating signed distance field values into image layers and subsequently stacking the layers to form a 3D representation of the space surrounding the ego. Furthermore, the system can predict and display various ground markings, expanding its functionality beyond traditional lane detection.

### CROSS-REFERENCE TO RELATED APPLICATIONS

This application claims priority to U.S. Provisional Patent Application No. 63/563,939, filed Mar. 11, 2024, which is incorporated herein by reference in its entirely for all purposes.

### TECHNICAL FIELD

The present disclosure generally relates to artificial intelligence-based modeling techniques to analyze image data and predict occupancy attributes for an ego's surroundings.

### BACKGROUND

Autonomous navigation technology used for autonomous vehicles and robots (collectively, egos) has become more prevalent due to rapid advancements in computer technology. These advances can allow for safer and more reliable autonomous navigation of egos. Egos often need to navigate through complex and dynamic environments and terrains that may include vehicles, traffic, pedestrians, cyclists, and various other static or dynamic obstacles. Understanding the egos' surroundings is necessary for informed and competent decision-making to avoid collisions.

### SUMMARY

For the aforementioned reasons, there is a desire for methods and systems that can analyze an ego's surroundings and predict objects having mass present within the ego's surroundings. Specifically, a trained artificial intelligence (AI) model used within a particular AI architecture can predict occupancy data associated with the space surrounding the ego. As used herein, occupancy data or occupancy attributes may refer to whether a defined space is occupied by an object having mass (e.g., occupied or unoccupied).

There is also a desire for methods and systems that can analyze an ego's surroundings and identify/evaluate different surfaces for objects occupying the ego's surroundings. Specifically, the trained AI model may determine the surface attributes of the objects occupying the space surrounding the ego.

Using the methods and systems discussed herein, a trained AI model may generate a queryable outputs corresponding to a three-dimensional (3D) representation of an ego's surroundings. As used herein, a queryable output can refer to data that represents the ego's surroundings. This output allows other systems or applications to retrieve spatial, object, and environmental information by querying specific aspects of the generated data. For instance, the data may include voxel-based occupancy determinations, object classifications, positional coordinates, or other features relevant to autonomous navigation and decision-making. For instance, an autonomous system of an ego may use the queryable outputs to determine whether a voxel is occupied and therefore, determine various actions regarding how to navigate the ego.

The AI model may use image data received from an ego's camera and predict a 3D structure of the driving surface around the ego. As used herein, driving surface applies to any navigation of an ego or any other vehicle on a surface, regardless of whether designated for driving and regardless of whether performed autonomously or via an operator. The dataset may be used by an autonomous navigation software and/or processor to navigate the ego. Using the methods and systems discussed herein, the AI model may determine whether a surface is navigable, whether the surface includes a hillcrest (and if so, how steep is the hillcrest), whether the hillcrest is trending up or down, whether the road is hilly, where the lanes and/or shoulders are located, whether the road has any markings (paint lines), where there are any speed bumps or potholes, and the like. That is, the driving surface may be analyzed using the AI model discussed herein. For instance, the AI model may determine whether a high ramp has a banked or a simple curve, whether the ramp has any elevation changes, and the like.

In embodiments, a method comprises inputting, by at least one processor using one or more cameras of an ego, image data of a space around the ego into an artificial intelligence model; predicting, by the at least one processor executing the artificial intelligence model, an occupancy attribute of a plurality of voxels corresponding to the space around the ego; predicting, by the at least one processor using the artificial intelligence model, a signed distance value for at least one occupied voxel indicating a distance between the occupied voxel and a nearest occupied voxel; and executing, by the at least one processor, a rendering protocol to display a representation of one or more objects within the space around the ego using the signed distance value for a set of voxels corresponding to the space around the ego.

The method may further comprise predicting, by the at least one processor using the artificial intelligence model, an existence of paint associated with at least one voxel.

The at least one voxel may be on a driving surface within the space surrounding the ego.

The rendering protocol may comprise generating a set of 2D rendering layers corresponding to the one or more objects, wherein an attribute of a voxel within at least one 2D rendering layer corresponds to a signed distance value of that voxel.

The attribute may be determined in accordance with whether the signed distance value is a positive value or a negative value.

The signed distance value may be a positive value, a corresponding voxel is depicted as transparent.

The signed distance value may be a negative value, a corresponding voxel is depicted as non-transparent.

The method may further comprise generating, by the at least one processor, a signed distance field grid representing the space around the ego.

The artificial intelligence model may be trained using a sensor attribute corresponding to a signed distance of a training course.

The artificial intelligence model may only ingest 2D sensor data (e.g., visual data) associated with the space surrounding the ego.

The method may further comprise identifying, by the at least one processor, a distance between the ego and at least one object within the space surrounding the ego, wherein at least one visual attribute of the at least one object, when rendered by the at least one processor, corresponds to the distance.

In another embodiment, a system comprises a computer-readable medium including non-transitory instructions that when executed cause at least one processor to: input, using one or more cameras of an ego, image data of a space around the ego into an artificial intelligence model; predict, executing the artificial intelligence model, an occupancy attribute of a plurality of voxels corresponding to the space around the ego; predict, using the artificial intelligence model, a signed distance value for at least one occupied voxel indicating a distance between the occupied voxel and a nearest occupied voxel; and execute a rendering protocol to display a representation of one or more objects within the space around the ego using the signed distance value for a set of voxels corresponding to the space around the ego.

The instruction may further cause the at least one processor to predict, using the artificial intelligence model, an existence of paint associated with at least one voxel.

The at least one voxel may be on a driving surface within the space surrounding the ego.

The rendering protocol may comprise generating a set of 2D rendering layers corresponding to the one or more objects, wherein an attribute of a voxel within at least one 2D rendering layer may correspond to a signed distance value of that voxel.

The attribute may be determined in accordance with whether the signed distance value is a positive value or a negative value.

When the signed distance value is a positive value, a corresponding voxel may be depicted as transparent, and wherein when the signed distance value is a negative value, a corresponding voxel may be depicted as non-transparent.

The artificial intelligence model may only ingest 2D sensor data (e.g., visual data) associated with the space surrounding the ego.

In yet other embodiments, a system comprises an ego including one or more cameras, wherein the ego is configured to communicate with at least one processor, wherein the at least one processor is configured to: input, using the one or more cameras of the ego, image data of a space around the ego into an artificial intelligence model; predict, executing the artificial intelligence model, an occupancy attribute of a plurality of voxels corresponding to the space around the ego; predict, using the artificial intelligence model, a signed distance value for at least one occupied voxel indicating a distance between the occupied voxel and a nearest occupied voxel; and execute a rendering protocol to display a representation of one or more objects within the space around the ego using the signed distance value for a set of voxels corresponding to the space around the ego.

The artificial intelligence model may only ingest 2D sensor data (e.g., visual data) associated with the space surrounding the ego.

In embodiments, a method comprises determining, by at least one processor, whether an ego has entered a park-eligible area; reconstructing, by the processor, a space surrounding the ego by: executing an artificial intelligence model using one or more cameras of the ego to predict a signed distance value for at least one occupied voxel within the ego's surrounding, the signed distance value indicating a distance between the occupied voxel and a nearest occupied voxel; identifying, by the processor, using the artificial intelligence model and the reconstructed space surrounding the ego, one or more parking spots within the park-eligible area; receiving, by the at least one processor, a selection of at least one parking spot; and transmitting, by the at least one processor, data associated with the selected parking spot to an autonomous navigation engine along with an instruction to navigate the ego and park the ego in the selected parking spot.

The at least one processor may determine whether the ego has entered the park-eligible area based on at least one of a location of the ego matching a park-eligible location, identifying a sign within the space surrounding the ego indicating the park-eligible area, or a speed of the ego.

The at least one processor may determine whether the ego has entered the park-eligible area using a second artificial intelligence model that ingest data received from the one or more cameras of the ego.

The second artificial intelligence model may determine whether the ego has entered the park-eligible area based on an orientation of other vehicles within the park-eligible area.

The one or more parking spots may be selected based on a respective path attribute from the ego to the one or more parking spots.

The one or more parking spots may be selected based on paint line associated with each parking spot.

The one or more parking spots may be selected based on whether each parking spot includes a shaped group of painted voxels within its driving surface.

The method may further comprise revising, by the at least one processor, a visual attribute of the selected parking spot.

The at least one parking spot may require parallel parking the ego.

The method may further comprise displaying, by the at least one processor, a visual indicator for at least one identified parking spot.

In another embodiment, a system comprises a computer-readable medium including non-transitory instructions that when executed cause at least one processor to: determine whether an ego has entered a park-eligible area; reconstruct a space surrounding the ego by: executing an artificial intelligence model using one or more cameras of the ego to predict a signed distance value for at least one occupied voxel within the ego's surrounding, the signed distance value indicating a distance between the occupied voxel and a nearest occupied voxel; identify using the artificial intelligence model and the reconstructed space surrounding the ego, one or more parking spots within the park-eligible area; receive a selection of at least one parking spot; and transmit data associated with the selected parking spot to an autonomous navigation engine along with an instruction to navigate the ego and park the ego in the selected parking spot.

The at least one processor may determine whether the ego has entered the park-eligible area based on at least one of a location of the ego matching a park-eligible location, identifying a sign within the space surrounding the ego indicating the park-eligible area, or a speed of the ego.

The at least one processor may determine whether the ego has entered the park-eligible area using a second artificial intelligence model that ingest data received from the one or more cameras of the ego.

The second artificial intelligence model may determine whether the ego has entered the park-eligible area based on an orientation of other vehicles within the park-eligible area.

The one or more parking spots are selected based on a respective path attribute from the ego to the one or more parking spots.

The one or more parking spots may be selected based on paint line associated with each parking spot.

The one or more parking spots may be selected based on whether each parking spot includes a shaped group of painted voxels within its driving surface.

In another embodiment, a system comprises an ego including one or more cameras, the ego in communication with at least one processor that is configured to: determine whether an ego has entered a park-eligible area; reconstruct a space surrounding the ego by: executing an artificial intelligence model using one or more cameras of the ego to predict a signed distance value for at least one occupied voxel within the ego's surrounding, the signed distance value indicating a distance between the occupied voxel and a nearest occupied voxel; identify using the artificial intelligence model and the reconstructed space surrounding the ego, one or more parking spots within the park-eligible area; receive a selection of at least one parking spot; and transmit data associated with the selected parking spot to an autonomous navigation engine along with an instruction to navigate the ego and park the ego in the selected parking spot.

The at least one processor may determine whether the ego has entered the park-eligible area based on at least one of a location of the ego matching a park-eligible location, identifying a sign within the space surrounding the ego indicating the park-eligible area, or a speed of the ego.

The at least one processor may determine whether the ego has entered the park-eligible area using a second artificial intelligence model that ingest data received from the one or more cameras of the ego.

### BRIEF DESCRIPTION OF THE DRAWINGS

Non-limiting embodiments of the present disclosure are described by way of example concerning the accompanying figures, which are schematic and are not intended to be drawn to scale. Unless indicated as representing the background art, the figures represent aspects of the disclosure.

FIG. 1A illustrates components of an AI-enabled visual data analysis system, according to embodiments.

FIG. 1B illustrates various sensors associated with an ego according to embodiments.

FIG. 1C illustrates the components of a vehicle, according to embodiments.

FIGS. 2A-2B illustrate flow diagrams of different processes executed in an AI-enabled visual data analysis system, according to embodiments.

FIGS. 3A-3B illustrates different occupancy maps generated in an AI-enabled visual data analysis system, according to embodiments.

FIGS. 4A-4C illustrate different views of a surface map generated in an AI-enabled visual data analysis system, according to embodiments.

FIG. 5 illustrates a flow diagram of a process for executing an AI model to generate a surface map, according to embodiments.

FIG. 6 illustrates a flow diagram of a process for executing an AI model to generate sign distance values for one or more voxels, according to embodiments.

FIG. 7 illustrates a visual representation of signed distance values calculated using the AI model, according to embodiments.

FIGS. 8A-8B illustrate reconstruction of objects viewed within a camera feed of an ego.

FIGS. 9A-9C represent different reconstructions of the same environment, according to embodiments.

FIGS. 10A-10C represent different reconstructions of spaces surrounding egos using the data predicted by the AI model, according to different embodiments.

FIG. 11 illustrates a flow diagram of a process for implementing an assisted parking application, according to embodiments.

FIGS. 12A-12D represent different interfaces of an assisted parking application using the AI model, according to embodiments.

FIGS. 13A-13D represent different interfaces of an assisted parking application using the AI model, according to embodiments.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

By implementing the methods described herein, a system may use a trained AI model to determine the occupancy status of different voxels of an image (or a video) of an ego's surroundings. The ego may be an autonomous vehicle (e.g., car, truck, bus, motorcycle, all-terrain vehicle, cart, boats, and flying vehicle), a robot, or other automated device. The ego may be configured to operate on a production line, within a building, home, or medical center or transport humans, deliver cargo, perform military functions, and the like. Within these environments, the ego may navigate amongst known or unknown paths to accomplish particular tasks or travel to particular destinations. There is a desire to avoid collisions during operation, so the ego may seek to understand the environment. For instance, in the context of an autonomous vehicle or a robot, the system may use a camera (or other visual sensor) to receive real-time or near real-time images of the ego's surroundings. The system may then execute the trained AI model to determine the occupancy status of the ego's surroundings. The AI model may divide the ego's surroundings into different voxels and then determine an occupancy status for each voxel. Accordingly, using the methods discussed herein, the system may generate a map of the ego's surroundings. Using the voxel data (e.g., coordinates of each voxel) and the corresponding occupancy status, the AI model (or sometimes another model using the data predicted by the AI model) may generate a map of the ego's surroundings.

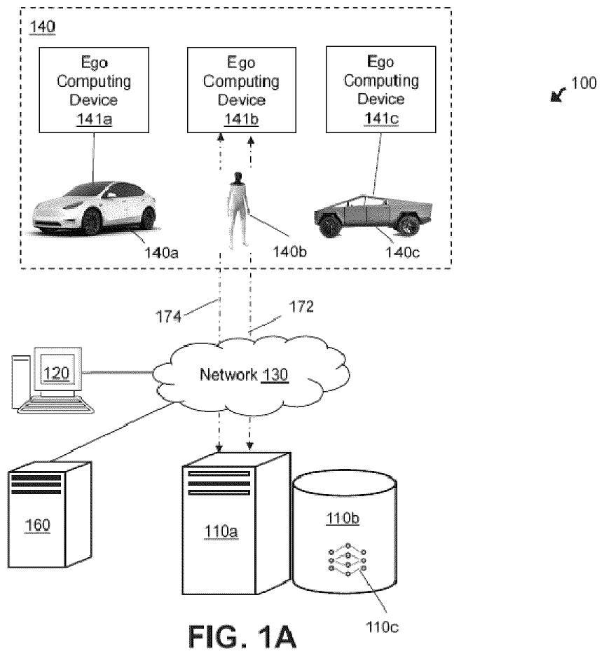

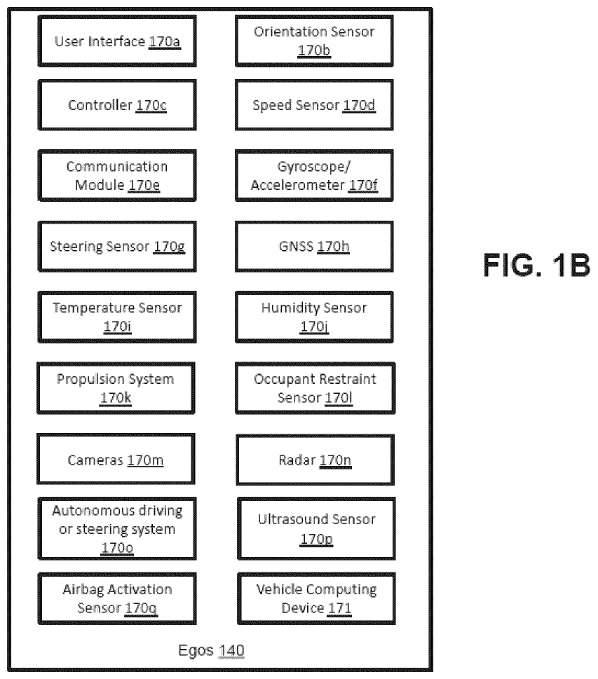

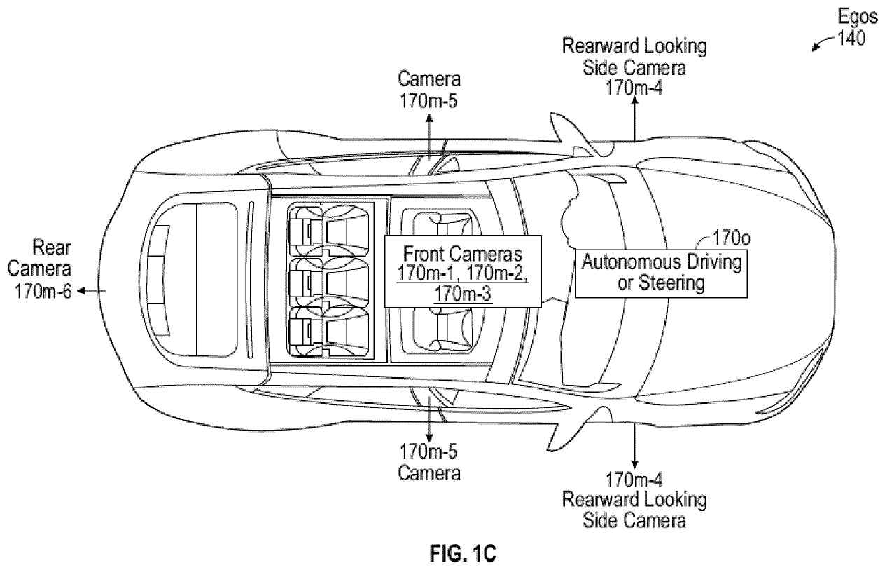

FIG. 1A is a non-limiting example of components of a system in which the methods and systems discussed herein can be implemented. For instance, an analytics server may train an AI model and use the trained AI model to generate an occupancy dataset and/or map for one or more egos. FIG. 1A illustrates components of an AI-enabled visual data analysis system 100. The system 100 may include an analytics server 110a, a system database 110b, an administrator computing device 120, egos 140a-b (collectively ego(s) 140), ego computing devices 141a-c (collectively ego computing devices 141), and a server 160. The system 100 is not confined to the components described herein and may include additional or other components not shown for brevity, which are to be considered within the scope of the embodiments described herein.

The above-mentioned components may be connected through a network 130. Examples of the network 130 may include, but are not limited to, private or public LAN, WLAN, MAN, WAN, and the Internet. The network 130 may include wired and/or wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, for example, a GSM (Global System for Mobile Communications), CDMA (Code Division Multiple Access), or an EDGE (Enhanced Data for Global Evolution) network.

The system 100 illustrates an example of a system architecture and components that can be used to train and execute one or more AI models, such the AI model(s) 110c. Specifically, as depicted in FIG. 1A and described herein, the analytics server 110a can use the methods discussed herein to train the AI model(s) 110c using data retrieved from the egos 140 (e.g., by using data streams 172 and 176). When the AI model(s) 110c have been trained, each of the egos 140 may have access to and execute the trained AI model(s) 110c. For instance, the vehicle 140a having the ego computing device 141a may transmit its camera feed to the trained AI model(s) 110c and may determine the occupancy status of its surroundings (e.g., data stream 174). Moreover, the data ingested and/or predicted by the AI model(s) 110c with respect to the egos 140 (at inference time) may also be used to improve the AI model(s) 110c. Therefore, the system 100 depicts a continuous loop that can periodically improve the accuracy of the AI model(s) 110c. Moreover, the system 100 depicts a loop in which data received the egos 140 can be used to at training phase in addition to the inference phase.

The analytics server 110a may be configured to collect, process, and analyze navigation data (e.g., images captured while navigating) and various sensor data collected from the egos 140. The collected data may then be processed and prepared into a training dataset. The training dataset may then be used to train one or more AI models, such as the AI model 110c. The analytics server 110a may also be configured to collect visual data from the egos 140. Using the AI model 110c (trained using the methods and systems discussed herein), the analytics server 110a may generate a dataset and/or an occupancy map for the egos 140. The analytics server 110a may display the occupancy map on the egos 140 and/or transmit the occupancy map/dataset to the ego computing devices 141, the administrator computing device 120, and/or the server 160.

In FIG. 1A, the AI model 110c is illustrated as a component of the system database 110b, but the AI model 110c may be stored in a different or a separate component, such as cloud storage or any other data repository accessible to the analytics server 110a.

The analytics server 110a may also be configured to display an electronic platform illustrating various training attributes for training the AI model 110c. The electronic platform may be displayed on the administrator computing device 120, such that an analyst can monitor the training of the AI model 110c. An example of the electronic platform generated and hosted by the analytics server 110a may be a web-based application or a website configured to display the training dataset collected from the egos 140 and/or training status/metrics of the AI model 110c.

The analytics server 110a may be any computing device comprising a processor and non-transitory machine-readable storage capable of executing the various tasks and processes described herein. Non-limiting examples of such computing devices may include workstation computers, laptop computers, server computers, and the like. While the system 100 includes a single analytics server 110a, the system 100 may include any number of computing devices operating in a distributed computing environment, such as a cloud environment.

The egos 140 may represent various electronic data sources that transmit data associated with their previous or current navigation sessions to the analytics server 110a. The egos 140 may be any apparatus configured for navigation, such as a vehicle 140a and/or a truck 140c. The egos 140 are not limited to being vehicles and may include robotic devices as well. For instance, the egos 140 may include a robot 140b, which may represent a general purpose, bipedal, autonomous humanoid robot capable of navigating various terrains. The robot 140b may be equipped with software that enables balance, navigation, perception, or interaction with the physical world. The robot 140b may also include various cameras configured to transmit visual data to the analytics server 110a.

Even though referred to herein as an “ego,” the egos 140 may or may not be autonomous devices configured for automatic navigation. For instance, in some embodiments, the ego 140 may be controlled by a human operator or by a remote processor. The ego 140 may include various sensors, such as the sensors depicted in FIG. 1B. The sensors may be configured to collect data as the egos 140 navigate various terrains (e.g., roads). The analytics server 110a may collect data provided by the egos 140. For instance, the analytics server 110a may obtain navigation session and/or road/terrain data (e.g., images of the egos 140 navigating roads) from various sensors, such that the collected data is eventually used by the AI model 110c for training purposes.

As used herein, a navigation session corresponds to a trip where egos 140 travel a route, regardless of whether the trip was autonomous or controlled by a human. In some embodiments, the navigation session may be for data collection and model training purposes. However, in some other embodiments, the egos 140 may refer to a vehicle purchased, rented, leased, etc. by a consumer and the purpose of the trip may be categorized as everyday use. The navigation session may start when the egos 140 move from a non-moving position beyond a threshold distance (e.g., 0.1 miles, 100 feet) or exceed a threshold speed (e.g., over 0 mph, over 1 mph, over 5 mph). The navigation session may end when the egos 140 are returned to a non-moving position and/or are turned off (e.g., when a driver exits a vehicle).

The egos 140 may represent a collection of egos monitored by the analytics server 110a to train the AI model(s) 110c. For instance, a driver for the vehicle 140a may authorize the analytics server 110a to monitor data associated with their respective vehicle. As a result, the analytics server 110a may utilize various methods discussed herein to collect sensor/camera data and generate a training dataset to train the AI model(s) 110c accordingly. The analytics server 110a may then apply the trained AI model(s) 110c to analyze data associated with the egos 140 and to predict an occupancy map for the egos 140. Moreover, additional/ongoing data associated with the egos 140 can also be processed and added to the training dataset, such that the analytics server 110a re-calibrates the AI model(s) 110c accordingly. Therefore, the system 100 depicts a loop in which navigation data received from the egos 140 can be used to train the AI model(s) 110c. The egos 140 may include processors that execute the trained AI model(s) 110c for navigational purposes. While navigating, the egos 140 can collect additional data regarding their navigation sessions, and the additional data can be used to calibrate the AI model(s) 110c. That is, the egos 140 represent egos that can be used to train, execute/use, and re-calibrate the AI model(s) 110c. In a non-limiting example, the egos 140 represent vehicles purchased by customers that can use the AI model(s) 110c to autonomously navigate while simultaneously improving the AI model(s) 110c.

The egos 140 may be equipped with various technology allowing the egos to collect data from their surroundings and (possibly) navigate autonomously. For instance, the egos 140 may be equipped with inference chips to run self-driving software.

Various sensors for each ego 140 may monitor and transmit the collected data associated with different navigation sessions to the analytics server 110a. FIGS. 1B-C illustrate block diagrams of sensors integrated within the egos 140, according to embodiments. The number and position of each sensor discussed with respect to FIGS. 1B-C may depend on the type of ego discussed in FIG. 1A. For instance, the robot 140b may include different sensors than the vehicle 140a or the truck 140c. For instance, the robot 140b may not include the airbag activation sensor 170q. Moreover, the sensors of the vehicle 140a and the truck 140c may be positioned differently than illustrated in FIG. 1C.

As discussed herein, various sensors integrated within each ego 140 may be configured to measure various data associated with each navigation session. The analytics server 110a may periodically collect data monitored and collected by these sensors, wherein the data is processed in accordance with the methods described herein and used to train the AI model 110c and/or execute the AI model 110c to generate the occupancy map.

The egos 140 may include a user interface 170a. The user interface 170a may refer to a user interface of an ego computing device (e.g., the ego computing devices 141 in FIG. 1A). The user interface 170a may be implemented as a display screen integrated with or coupled to the interior of a vehicle, a heads-up display, a touchscreen, or the like. The user interface 170a may include an input device, such as a touchscreen, knobs, buttons, a keyboard, a mouse, a gesture sensor, a steering wheel, or the like. In various embodiments, the user interface 170a may be adapted to provide user input (e.g., as a type of signal and/or sensor information) to other devices or sensors of the egos 140 (e.g., sensors illustrated in FIG. 1B), such as a controller 170c.

The user interface 170a may also be implemented with one or more logic devices that may be adapted to execute instructions, such as software instructions, implementing any of the various processes and/or methods described herein. For example, the user interface 170a may be adapted to form communication links, transmit and/or receive communications (e.g., sensor signals, control signals, sensor information, user input, and/or other information), or perform various other processes and/or methods. In another example, the driver may use the user interface 170a to control the temperature of the egos 140 or activate its features (e.g., autonomous driving or steering system 170o). Therefore, the user interface 170a may monitor and collect driving session data in conjunction with other sensors described herein. The user interface 170a may also be configured to display various data generated/predicted by the analytics server 110a and/or the AI model 110c.

An orientation sensor 170b may be implemented as one or more of a compass, float, accelerometer, and/or other digital or analog device capable of measuring the orientation of the egos 140 (e.g., magnitude and direction of roll, pitch, and/or yaw, relative to one or more reference orientations such as gravity and/or magnetic north). The orientation sensor 170b may be adapted to provide heading measurements for the egos 140. In other embodiments, the orientation sensor 170b may be adapted to provide roll, pitch, and/or yaw rates for the egos 140 using a time series of orientation measurements. The orientation sensor 170b may be positioned and/or adapted to make orientation measurements in relation to a particular coordinate frame of the egos 140.

A controller 170c may be implemented as any appropriate logic device (e.g., processing device, microcontroller, processor, application-specific integrated circuit (ASIC), field programmable gate array (FPGA), memory storage device, memory reader, or other device or combinations of devices) that may be adapted to execute, store, and/or receive appropriate instructions, such as software instructions implementing a control loop for controlling various operations of the egos 140. Such software instructions may also implement methods for processing sensor signals, determining sensor information, providing user feedback (e.g., through user interface 170a), querying devices for operational parameters, selecting operational parameters for devices, or performing any of the various operations described herein.

A communication module 170e may be implemented as any wired and/or wireless interface configured to communicate sensor data, configuration data, parameters, and/or other data and/or signals to any feature shown in FIG. 1A (e.g., analytics server 110a). As described herein, in some embodiments, communication module 170e may be implemented in a distributed manner such that portions of communication module 170e are implemented within one or more elements and sensors shown in FIG. 1B. In some embodiments, the communication module 170e may delay communicating sensor data. For instance, when the egos 140 do not have network connectivity, the communication module 170e may store sensor data within temporary data storage and transmit the sensor data when the egos 140 are identified as having proper network connectivity.

A speed sensor 170d may be implemented as an electronic pitot tube, metered gear or wheel, water speed sensor, wind speed sensor, wind velocity sensor (e.g., direction and magnitude), and/or other devices capable of measuring or determining a linear speed of the egos 140 (e.g., in a surrounding medium and/or aligned with a longitudinal axis of the egos 140) and providing such measurements as sensor signals that may be communicated to various devices.

A gyroscope/accelerometer 170f may be implemented as one or more electronic sextants, semiconductor devices, integrated chips, accelerometer sensors, or other systems or devices capable of measuring angular velocities/accelerations and/or linear accelerations (e.g., direction and magnitude) of the egos 140, and providing such measurements as sensor signals that may be communicated to other devices, such as the analytics server 110a. The gyroscope/accelerometer 170f may be positioned and/or adapted to make such measurements in relation to a particular coordinate frame of the egos 140. In various embodiments, the gyroscope/accelerometer 170f may be implemented in a common housing and/or module with other elements depicted in FIG. 1B to ensure a common reference frame or a known transformation between reference frames.

A global navigation satellite system (GNSS) 170h may be implemented as a global positioning satellite receiver and/or another device capable of determining absolute and/or relative positions of the egos 140 based on wireless signals received from space-born and/or terrestrial sources, for example, and capable of providing such measurements as sensor signals that may be communicated to various devices. In some embodiments, the GNSS 170h may be adapted to determine the velocity, speed, and/or yaw rate of the egos 140 (e.g., using a time series of position measurements), such as an absolute velocity and/or a yaw component of an angular velocity of the egos 140.

A temperature sensor 170i may be implemented as a thermistor, electrical sensor, electrical thermometer, and/or other devices capable of measuring temperatures associated with the egos 140 and providing such measurements as sensor signals. The temperature sensor 170i may be configured to measure an environmental temperature associated with the egos 140, such as a cockpit or dash temperature, for example, which may be used to estimate a temperature of one or more elements of the egos 140.

A humidity sensor 170j may be implemented as a relative humidity sensor, electrical sensor, electrical relative humidity sensor, and/or another device capable of measuring a relative humidity associated with the egos 140 and providing such measurements as sensor signals.

A steering sensor 170g may be adapted to physically adjust a heading of the egos 140 according to one or more control signals and/or user inputs provided by a logic device, such as controller 170c. Steering sensor 170g may include one or more actuators and control surfaces (e.g., a rudder or other type of steering or trim mechanism) of the egos 140 and may be adapted to physically adjust the control surfaces to a variety of positive and/or negative steering angles/positions. The steering sensor 170g may also be adapted to sense a current steering angle/position of such steering mechanism and provide such measurements.

A propulsion system 170k may be implemented as a propeller, turbine, or other thrust-based propulsion system, a mechanical wheeled and/or tracked propulsion system, a wind/sail-based propulsion system, and/or other types of propulsion systems that can be used to provide motive force to the egos 140. The propulsion system 170k may also monitor the direction of the motive force and/or thrust of the egos 140 relative to a coordinate frame of reference of the egos 140. In some embodiments, the propulsion system 170k may be coupled to and/or integrated with the steering sensor 170g.

An occupant restraint sensor 170l may monitor seatbelt detection and locking/unlocking assemblies, as well as other passenger restraint subsystems. The occupant restraint sensor 170l may include various environmental and/or status sensors, actuators, and/or other devices facilitating the operation of safety mechanisms associated with the operation of the egos 140. For example, occupant restraint sensor 170l may be configured to receive motion and/or status data from other sensors depicted in FIG. 1B. The occupant restraint sensor 170l may determine whether safety measurements (e.g., seatbelts) are being used.

Cameras 170m may refer to one or more cameras integrated within the egos 140 and may include multiple cameras integrated (or retrofitted) into the ego 140, as depicted in FIG. 1C. The cameras 170m may be interior- or exterior-facing cameras of the egos 140. For instance, as depicted in FIG. 1C, the egos 140 may include one or more interior-facing cameras 170m-1. These cameras may monitor and collect footage of the occupants of the egos 140. The egos 140 may also include a forward-looking side camera 170m-2, a camera 170m-3 (e.g., integrated within the door frame), and a rearward-looking side camera 170m-4.

In some embodiments, the methods and systems discussed herein can operate exclusively with 2D sensors (e.g., 2D cameras) that may explicitly exclude depth cameras, time-of-flight (ToF) sensors, and other specialized depth-sensing technologies. The AI model and processing pipelines discussed herein can be trained to extract spatial and environmental information solely from monocular or stereo 2D image inputs without relying on depth estimation hardware. This ensures compatibility with 2D camera systems that only transmit captured images without any additional depth data, while maintaining robust performance in autonomous navigation and visual data analysis.

Referring to FIG. 1B, a radar 170n and ultrasound sensors 170p may be configured to monitor the distance of the egos 140 to other objects, such as other vehicles or immobile objects (e.g., trees or garage doors). The radar 170n and the ultrasound sensors 170p may be integrated into the egos 140 as depicted in FIG. 1C. The egos 140 may also include an autonomous driving or steering system 170o configured to use data collected via various sensors (e.g., radar 170n, speed sensor 170d, and/or ultrasound sensors 170p) to autonomously navigate the ego 140.

Therefore, autonomous driving or steering system 170o may analyze various data collected by one or more sensors described herein to identify driving data. For instance, autonomous driving or steering system 170o may calculate a risk of forward collision based on the speed of the ego 140 and its distance to another vehicle on the road. The autonomous driving or steering system 170o may also determine whether the driver is touching the steering wheel. The autonomous driving or steering system 170o may transmit the analyzed data to various features discussed herein, such as the analytics server.

An airbag activation sensor 170q may anticipate or detect a collision and cause the activation or deployment of one or more airbags. The airbag activation sensor 170q may transmit data regarding the deployment of an airbag, including data associated with the event causing the deployment.

Referring back to FIG. 1A, the administrator computing device 120 may represent a computing device operated by a system administrator. The administrator computing device 120 may be configured to display data retrieved or generated by the analytics server 110a (e.g., various analytic metrics and risk scores), wherein the system administrator can monitor various models utilized by the analytics server 110a, review feedback, and/or facilitate the training of the AI model(s) 110c maintained by the analytics server 110a.

The ego(s) 140 may be any device configured to navigate various routes, such as the vehicle 140a or the robot 140b. As discussed with respect to FIGS. 1B-C, the ego 140 may include various telemetry sensors. The egos 140 may also include ego computing devices 141. Specifically, each ego may have its own ego computing device 141. For instance, the truck 140c may have the ego computing device 141c. For brevity, the ego computing devices are collectively referred to as the ego computing device(s) 141. The ego computing devices 141 may control the presentation of content on an infotainment system of the egos 140, process commands associated with the infotainment system, aggregate sensor data, manage communication of data to an electronic data source, receive updates, and/or transmit messages. In one configuration, the ego computing device 141 communicates with an electronic control unit. In another configuration, the ego computing device 141 is an electronic control unit. The ego computing devices 141 may comprise a processor and a non-transitory machine-readable storage medium capable of performing the various tasks and processes described herein. For example, the AI model(s) 110c described herein may be stored and performed (or directly accessed) by the ego computing devices 141. Non-limiting examples of the ego computing devices 141 may include a vehicle multimedia and/or display system.

In examples of how the AI model(s) 110c can be trained, the analytics server 110a may collect data from egos 140 to train the AI model(s) 110c. Before executing the AI model(s) 110c to generate/predict an occupancy dataset, the analytics server 110a may train the AI model(s) 110c using various methods. The training allows the AI model(s) 110c to ingest data from one or more cameras of one or more egos 140 (without the need to receive radar data) and predict occupancy data for the ego's surroundings. The operation described in this example may be executed by any number of computing devices operating in the distributed computing system described in FIGS. 1A and 1B (e.g., a processor of the egos 140.

The analytics server 110a may generate, using a sensor of an ego 140, a first dataset having a first set of data points where each data point within the first set of data points corresponds to a location and a sensor attribute of at least one voxel of space around the egos 140, the sensor attribute indicating whether the at least one voxel is occupied by an object having mass. The sensor information included within the first dataset can then be coupled with a secondary dataset that includes images (e.g., a video feed) of the same location(s) in order to train the AI model. To train the AI model(s) 110c, the analytics server 110a may first employ one or more of the egos 140 to drive a particular route. While driving, the egos 140 may use one or more of their sensors (including one or more cameras) to generate navigation session data. For instance, the one or more of the egos 140 equipped with various sensors can navigate the designated route. As the one or more of the egos 140 traverse the terrain, their sensors may capture continuous (or periodic) data of their surroundings. The sensors may indicate an occupancy status of the one or more egos' 140 surroundings. For instance, the sensor data may indicate various objects having mass in the surroundings of the one or more of the egos 140 as they navigate their route.

The analytics server 110a may generate a first dataset using the sensor data received from the one or more of the egos 140. The first dataset may indicate the occupancy status of different voxels within the surroundings of the one or more of the egos 140. As used herein in some embodiments, a voxel is a three-dimensional pixel, forming a building block of the surroundings of the one or more of the egos 140. Within the first dataset, each voxel may encapsulate sensor data indicating whether a mass was identified for that particular voxel. Mass, as used herein, may indicate or represent any object identified using the sensor. For instance, in some embodiments, the egos 140 may be equipped with a 3D sensor that identifies a distance by emitting laser pulses and measuring the time it takes for these pulses to travel to an object (having mass) and back. Via detecting that the laser pulse has been reflected back, the 3D sensor may also detect the mass. This information, combined with other sensor data, may be analyzed to identify and characterize different masses or objects within the surroundings of the one or more of the egos 140.

In some configurations, a voxel may be considered as occupied based on its visual attribute indicating that the voxel appears to be occupied, though the voxel is not occupied by a mass or an object. For instance, a voxel of the ego's surroundings may be considered occupied if a 2D sensor of the ego's feed is analyzed and that voxel appears to be occupied by fog.

Various additional data may be used to indicate whether a voxel of the one or more egos 140 surroundings is occupied by an object having mass or not. For instance, in some embodiments, a digital map of the surroundings (e.g., a digital map of the route being traversed by the ego) of the one or more egos 140 may be used to determine the occupancy status of each voxel. In some embodiments, the digital map may comprise 3D sensor data indicating the occupancy status of the ego's surroundings. This digital map can then be paired and compared against a 2D image received from a camera, enabling the identification of voxel occupancy by aligning features detected in the 2D image with known occupancy data from the digital map. This paired data can then be used to train the AI model, allowing it to learn correlations between 2D visual features and 3D occupancy information, ultimately improving the AI model's ability to infer scene depth and object presence using only 2D camera inputs.

In operation, as the one or more egos 140 navigate, their sensors collect data and transmit the data to the analytics server 110a, as depicted in the data stream 176. For instance, the ego 140 computing devices 141 may transmit sensor data to the analytics server 110a using the data stream 176.

The analytics server 110a may generate, using a camera of the ego 140, a second dataset having a second set of data points where each data point within the second set of data points corresponds to a location and an image attribute of at least one voxel of space around the ego 140.

The analytics server 110a may receive a camera feed of the one or more egos 140 navigating the same route as in the first step. In some embodiments, the analytics server 110a may simultaneously (or contemporaneously) perform the first step and the second step. Alternatively, two (or more) different egos 140 may navigate the same route where one ego transmits its sensor data, and the second ego 140 transmits its camera feed.

The one or more egos 140 may include one or more high-resolution cameras that capture a continuous stream of visual data from the surroundings of the one or more egos 140 as the one or more egos 140 navigate through the route. The analytics server 110a may then generate a second dataset using the camera feed where visual elements/depictions of different voxels of the one or more egos' 140 surroundings are included within the second dataset. In some examples, the second dataset may represent a collection of images captured from the same location that was previously analyzed by the 3D sensor (the first dataset), ensuring that the visual elements correspond to the same spatial environment. Because the images depict different voxels of the ego's surroundings, they can be paired with the 3D sensor data to establish a direct correlation between 2D visual features and 3D occupancy information. This paired dataset can then be used to train the AI model, enabling the AI model to infer voxel occupancy using only 2D camera inputs. In operation, as the one or more egos 140 navigate, their cameras collect data and transmit the data to the analytics server 110a, as depicted in the data stream 172. For instance, the ego computing devices 141 may transmit image data to the analytics server 110a using the data stream 172.

The analytics server 110a may train an AI model using the first and second datasets, whereby the AI model 110c correlates at least a portion of the data points within the first set of data points with a corresponding data point within the second set of data points, using each data point's respective location to train itself, wherein, once trained, the AI model 110c is configured to receive a camera feed from a new ego 140 and predict an occupancy status of at least one voxel of the camera feed.

Using the first and second datasets, the analytics server 110a may train the AI model(s) 110c, such that the AI model(s) 110c may correlate different visual attributes of a voxel (within the camera feed within the second dataset) to an occupancy status of that voxel (within the first dataset). In this way, once trained, the AI model(s) 110c may receive a camera feed (e.g., from a new ego 140) without receiving sensor data and then determine each (or sometimes a portion of) voxel's occupancy status for the new ego 140.

The analytics server 110a may generate a training dataset that includes the first and second datasets. The analytics server 110a may use the first dataset as ground truth. For instance, the first dataset may indicate the different location of voxels and their occupancy status. The second dataset may include a visual (e.g., a camera feed) illustration of the same voxel. Using the first dataset, the analytics server 110a may label the data, such that data record(s) associated with each voxel corresponding to an object are indicated as having a positive occupancy status. In some examples, the visual data is processed in correlation with voxel-based occupancy information derived from the first dataset. Specifically, each voxel is labeled with an occupancy status based on its association with an object, and the corresponding pixel data from the 2D camera feed is mapped to these labeled voxels. For instance, if a group of voxels is identified as occupied within the first dataset, a corresponding group of voxels within the second dataset (corresponding to the same location or object) can be labeled as occupied.

The labeling of the occupancy status of different voxels may be performed automatically and/or manually. For instance, in some embodiments, the analytics server 110a may use human reviewers to label the data. For instance, as discussed herein, the camera feed from one or more cameras of a vehicle may be shown on an electronic platform to a human reviewer for labeling. Additionally or alternatively, the data in its entirety may be ingested by the AI model(s) 110c where the AI model(s) 110c identifies corresponding voxels, analyzes the first digital map, and correlates the image(s) of each voxel to its respective occupancy status.

Using the ground truth, the AI model(s) 110c may be trained, such that each voxel's visual elements are analyzed and correlated to whether that voxel was occupied by a mass. Therefore, the AI model 110c may retrieve the occupancy status of each voxel (using the first dataset) and use the information as ground truth. The AI model(s) 110c may also retrieve visual attributes of the same voxel using the second dataset.

In some embodiments, the analytics server 110a may use a supervised method of training. For instance, using the ground truth and the visual data received, the AI model(s) 110c may train itself, such that it can predict an occupancy status for a voxel using only an image of that voxel. As a result, when trained, the AI model(s) 110c may receive a camera feed, analyze the camera feed, and determine an occupancy status for each voxel within the camera feed (without the need to use a radar). In some embodiments, the AI model(s) may ingest the labeled data and use a supervised method for training.

The analytics server 110a may feed the series of training datasets to the AI model(s) 110c and obtain a set of predicted outputs (e.g., predicted occupancy status). The analytics server 110a may then compare the predicted data with the ground truth data to determine a difference and train the AI model(s) 110c by adjusting the AI model's 110c internal weights and parameters proportional to the determined difference according to a loss function. The analytics server 110a may train the AI model(s) 110c in a similar manner until the trained AI model's 110c prediction is accurate to a certain threshold (e.g., recall or precision).

Additionally, or alternatively, the analytics server 110a may use an unsupervised method where the training dataset is not labeled. Because labeling the data within the training dataset may be time-consuming and may require excessive computing power, the analytics server 110a may utilize unsupervised training techniques to train the AI model 110c. The training paradigms discussed herein can also include unsupervised training. For instance, the AI model(s) may ingest the first dataset and the second dataset where the voxels are not labeled and use an unsupervised paradigm for training. Because the two datasets correspond to the same location, the AI model(s) may identify correlations between sensor and image data for training purposes.

After the AI model 110c is trained, it can be used by an ego 140 to predict occupancy data of the one or more egos' 140 surroundings. For instance, the AI model(s) 110c may divide the ego's surroundings into different voxels and predict an occupancy status for each voxel. In some embodiments, the AI model(s) 110c (or the analytics server 110a using the data predicted using the AI model 110c) may generate an occupancy map or occupancy network representing the surroundings of the one or more egos 140 at any given time.

In another example of how the AI model(s) 110c may be used, after training the AI model(s) 110c, analytics server 110a (or a local chip of an ego 140) may collect data from an ego (e.g., one or more of the egos 140) to predict an occupancy dataset for the one or more egos 140. This example describes how the AI model(s) 110c can be used to predict occupancy data in real-time or near real-time for one or more egos 140. This configuration may have a processor, such as the analytics server 110a, execute the AI model. However, one or more actions may be performed locally via, for example, a chip located within the one or more egos 140. In operation, the AI model(s) 110c may be executed via an ego 140 locally, such that the results can be used to autonomously navigate itself.

The processor may input, using a camera of an ego object 140, image data of a space around the ego object 140 into an AI model 110c. The processor may collect and/or analyze data received from various cameras of one or more egos 140 (e.g., exterior-facing cameras). In another example, the processor may collect, and aggregate footage recorded by one or more cameras of the egos 140. The processor may then transmit the footage to the AI model(s) 110c trained using the methods discussed herein.

The processor may predict, by executing the AI model 110c, an occupancy attribute of a plurality of voxels. The AI model(s) 110c may use the methods discussed herein to predict an occupancy status for different voxels surrounding the one or more egos 140 using the image data received.

The processor may generate a dataset based on the plurality of voxels and their corresponding occupancy attribute. The analytics server 110a may generate a dataset that includes the occupancy status of different voxels in accordance with their respective coordinate values. The dataset may be a query-able dataset available to transmit the predicted occupancy status to different software modules.

In operation, the one or more egos 140 may collect image data from their cameras and transmit the image data to the processor (placed locally on the one or more egos 140) and/or the analytics server 110a, as depicted in the data stream 172. The processor may then execute the AI model(s) 110c to predict occupancy data for the one or more egos 140. If the prediction is performed by the analytics server 110a, then the occupancy data can be transmitted to the one or more egos 140 using the data stream 174. If the processor is placed locally within the one or more egos 140, then the occupancy data is transmitted to the ego computing devices 141 (not shown in FIG. 1A).

Using the methods discussed herein, the training of the AI model(s) 110c can be performed such that the execution of the AI model(s) 110c may be performed locally on any of the egos 140 (at inference time). The data collected (e.g., navigational data collected during the navigation of the egos 140, such as image data of a trip) can then be fed back into the AI model(s) 110c, such that the additional data can improve the AI model(s) 110c.

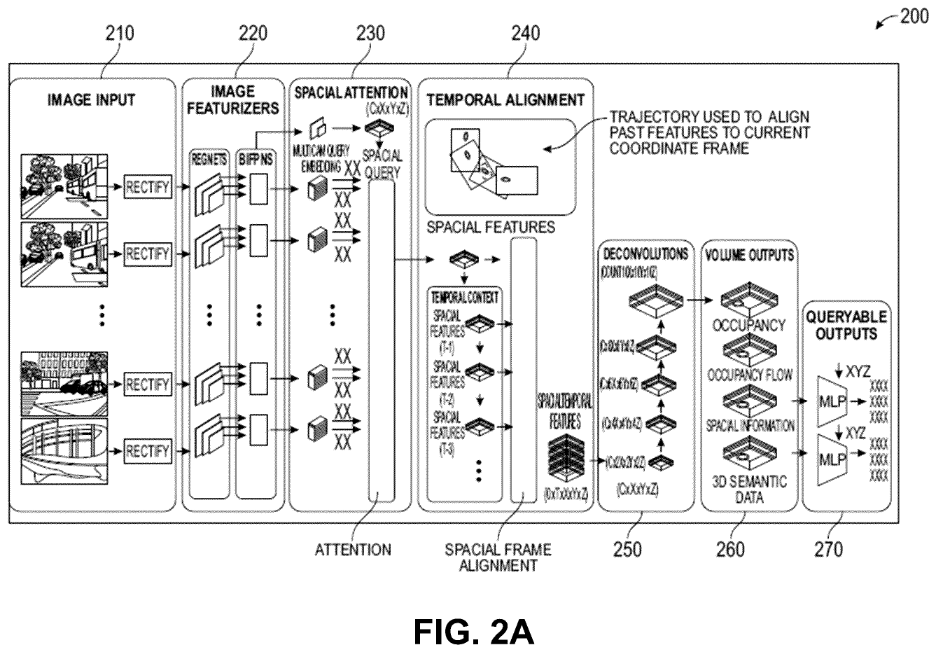

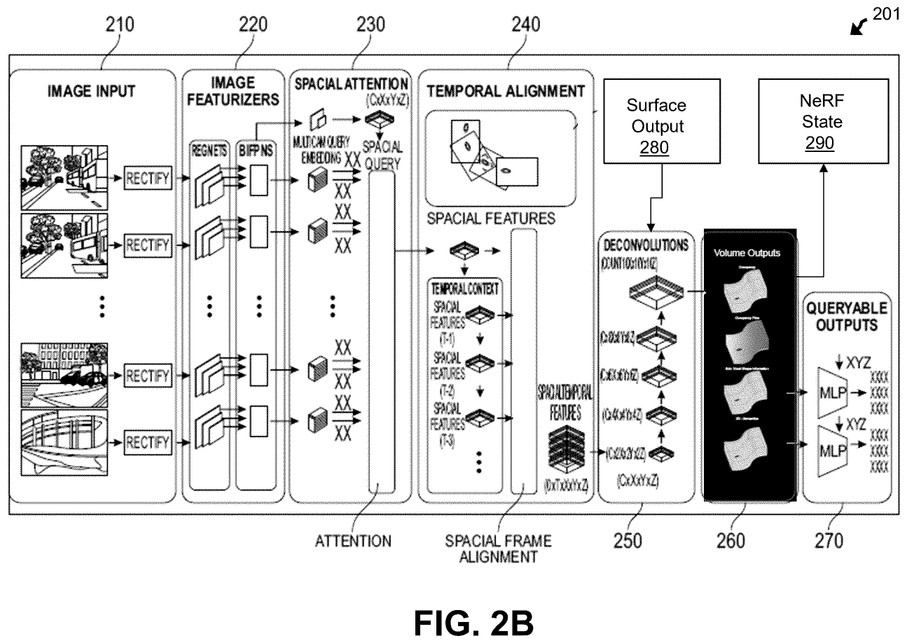

FIG. 2 illustrates a flow diagram of a method 200 executed in an AI-enabled, visual data analysis system, according to embodiments. The method 200 may include steps 210-270. However, other embodiments may include additional or alternative steps or may omit one or more steps. The method 200 is executed by an analytics server (e.g., a computer similar to the analytics server 110a). However, one or more steps of the method 200 may be executed by any number of computing devices operating in the distributed computing system described in FIGS. 1A-C (e.g., a processor of the ego 140 and/or ego computing devices 141). For instance, one or more computing devices of an ego may locally perform some or all steps described in FIG. 2.

FIG. 2 illustrates a model architecture of how image inputs can be ingested from an ego (step 210) and analyzed, such that query-able outputs are predicted (step 270). Using the methods and systems discussed herein, the analytics server may only ingest image data (e.g., 2D camera feed from an ego's surroundings without any depth information) to generate the query-able outputs. Therefore, the methods and systems discussed herein can operate without any data received from radar, LiDAR, or the like.

The query-able outputs (generated in the step 270) can be used for various purposes. In examples, the query-able outputs may be available to an autonomous driving module where various navigational decisions may be made based on whether a voxel of space surrounding an ego is predicted to be occupied. In examples, using the query-able outputs, the analytics server may generate a digital map illustrating the occupancy status of the ego's surroundings. For instance, the analytics server may generate a three-dimensional (3D) geometrical representation of the ego's surroundings. The digital map may be displayed on a computing device of the ego, for example.

As used herein, a voxel may refer to a volumetric pixel and may refer to a 3D equivalent of a pixel in 2D. Accordingly, a voxel may represent a defined point in a 3D grid within a volumetric space or environment around (e.g., surrounding) an ego. In some embodiments, the space surrounding the ego can be divided into different voxels, referred to as a voxel grid. As used herein, a voxel grid may refer to a set of cubes stacked (or arranged) together to represent objects in the space surrounding the ego. Each voxel may contain information about a specific location within the ego's surrounding space. Using the methods and systems discussed herein, an occupancy of each voxel may be evaluated. For instance, the analytics server (using the AI model discussed herein) may determine whether each voxel is occupied with an object having a mass. The voxel predictions may be aggregated into a dataset referred to herein as the query-able results. Using the query-able results, voxel information can be queried by a processor or a downstream software module (e.g., autonomous driving software/processor) to identify occupancy data of the ego's surroundings.

In some embodiments, a voxel may be designated as occupied if any portion of the voxel is occupied. Therefore, in some embodiments, each voxel may include a binary designation of 0 (unoccupied) or 1 (occupied). Alternatively, in some embodiments, the AI model may also predict detailed occupancy data inside/within a particular voxel. For instance, a voxel having a binary value of 1 (occupied) may be further analyzed at a more granular level, such that the occupancy of each point within the voxel is also determined. As used herein, a point may refer to a finer-grained spatial representation within a voxel, indicating specific locations inside the voxel where occupancy is determined. For instance, in some embodiments, rather than treating a voxel as a single binary unit (occupied or unoccupied), the AI model can analyze the internal structure of the voxel by assessing multiple discrete points within the voxel. This allows for a more detailed understanding of object presence within a voxel, improving the accuracy of occupancy predictions by capturing sub-voxel-level details. In some embodiments, an object may be curved. While some of the voxels (associated with the object) are completely occupied, some other voxels may be partially occupied. Those voxels may be divided into smaller voxels, such that some of the smaller voxels are unoccupied. As described herein, this method can be used to identify the shape of the object.

The method 200 starts with step 210 in which image data is received from one or more cameras of an ego. The method 200 visually illustrates how an AI model (trained using the methods discussed herein) can ingest the image data and generate query-able outputs that can indicate a volumetric occupancy of various voxels within an ego's surroundings. The image data may refer to any data received from one or more images of the ego.

The captured image data may then be featurized (step 220). An image featurizer or various featurization algorithms may be used to extract relevant and meaningful features from the image data received. Using the image featurizer, the image data may be transformed into data representations that capture important information about the content of the image. This allows the image data to be analyzed more efficiently.

In some embodiments, the AI model may perform the featurization discussed herein. In some other embodiments, a convolutional neural network may be used to featurize the image data. In one non-limiting example, as depicted, a RegNet (Regularized Neural Networks) may be used to transform the data into a BiFPN (Bi-directional Feature Pyramid Network). However, other protocols may also be used. In some other embodiments, a transformer may be used to featurize the image data.

After the image data is encoded/featurized, a transformer may be used to change the image data from 2D images into 3D images (step 230). As used herein, a transformer may refer to a neural network model (or a part of the model) that processes and integrates multiple 2D images to generate a coherent 3D representation of the ego's surroundings. In some embodiments, the transformer may utilize various attention protocols to learn spatial relationships between overlapping camera feeds and infer depth or structure from purely 2D image data. As discussed herein, in an example configuration, there may be eight distinct cameras in communication with the ego. As a result, the image data may include eight distinct camera feeds (one feed corresponding to each camera or other sensor) and may include overlapping views. The transformer may aggregate these separate camera feeds and generate one or more 3D representations using the received camera feeds.

The transformer may ingest three separate inputs: image key, image value, and 3D queries. The image key and image value may refer to attributes associated with the 2D image data received from the ego. For instance, these values may be outputted via image featurization (step 220). The transformer may also use an image query from the 3D space. The depicted spatial attention module may use a 3D query to analyze the 2D image key and image value. As depicted, the BiFPNs generated in the step 220 may be aggregated into a multi-camera query embedding and may be used to perform 3D spatial queries. In some embodiments, each voxel may have its own query. Using the 3D spatial query, the analytics server may identify a region within the 2D featurized image corresponding to a particular portion of the 3D representation. The identified region within the featurized image may then be analyzed to transform the multi-camera image data into a 3D representation of each voxel, which may produce a 3D representation of the ego's surroundings. Accordingly, the depicted spatial attention module may output a single 3D vector space representing the ego's surroundings. This, in effect, transforms (e.g., using encoder/decoder paradigm) the image data generated by all camera feeds into a top-down space or a 3D space representation of the ego's surroundings.

The steps 210-230 may be performed for each video frame received from each camera of the ego. For instance, at each timestamp, the steps 210-230 may be performed on eight distinct images received from the ego's eight different cameras. As a result, at each timestamp, the method 200 may produce one 3D space representation of the eight images. At step 240, the method 200 may fuse the 3D spaces (for different timestamps) together. This fusion may be done based on a timestamp of each set of images. For instance, the 3D space representations may be fused based on their respective timestamps (e.g., in a consecutive manner).

As depicted, the 3D space representation at timestamp t may be fused with the 3D space representation of the ego's surroundings at t-1, t-2, and t-3. As a result, the output may have both spatial and temporal information. This concept is depicted in FIG. 2 as the spatial-temporal features.

The spatial-temporal features may then be transformed into different voxels using deconvolution (step 250). As discussed herein, various data points are featurized and fused together. In this step 250, the method 200 may perform various mathematical operations to reverse this process, such that the fused data can be transformed back into different voxels. Deconvolution, as used herein, may refer to a mathematical operation used to reverse the effects of convolution.

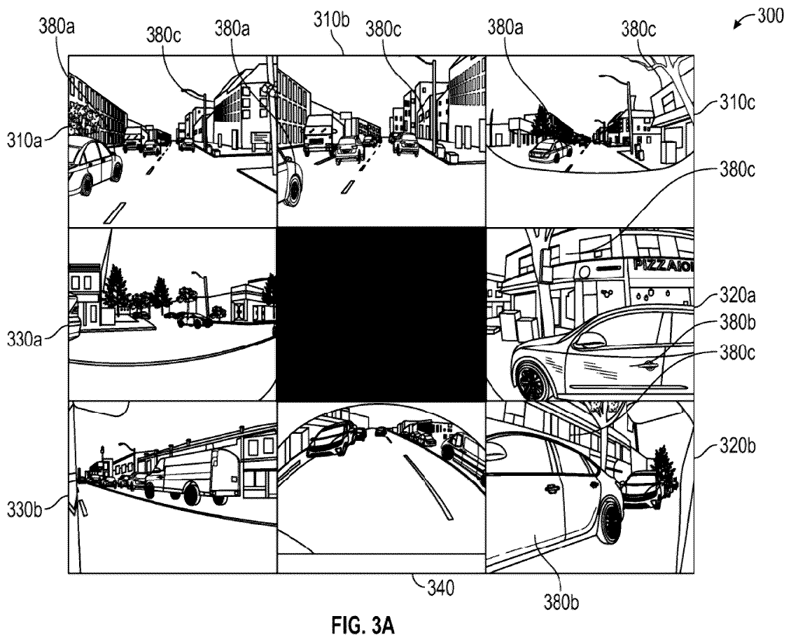

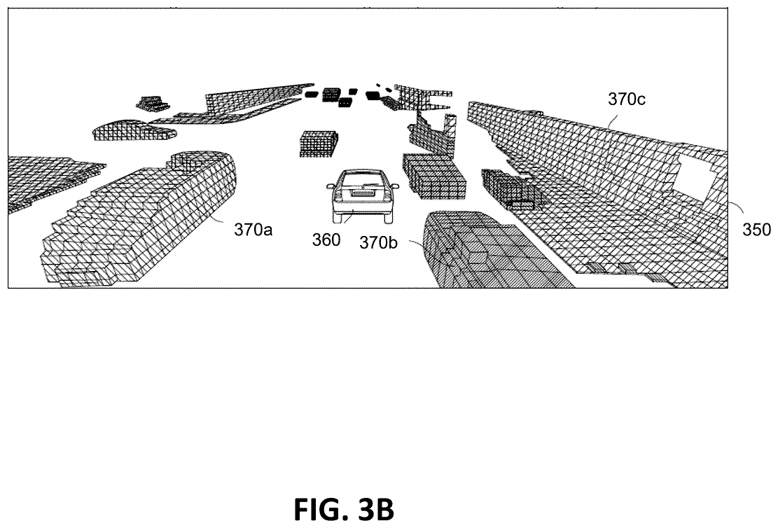

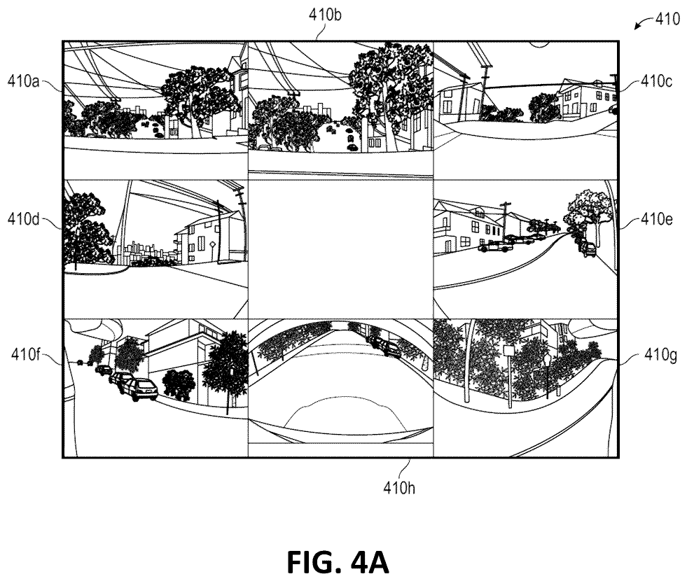

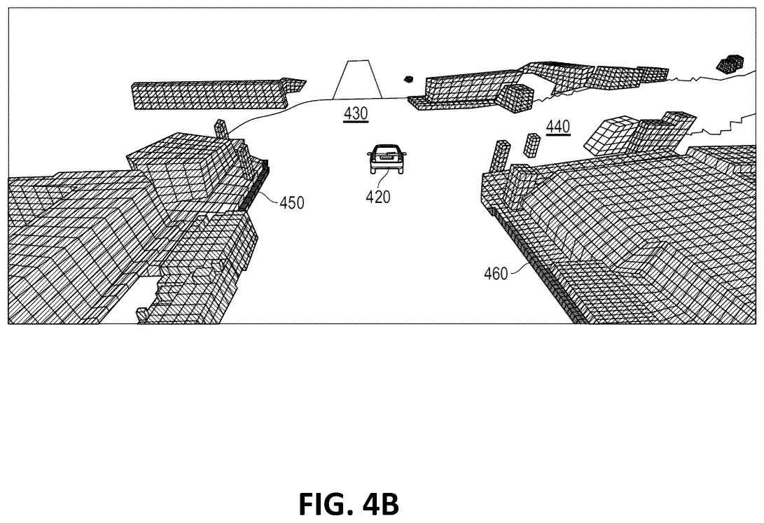

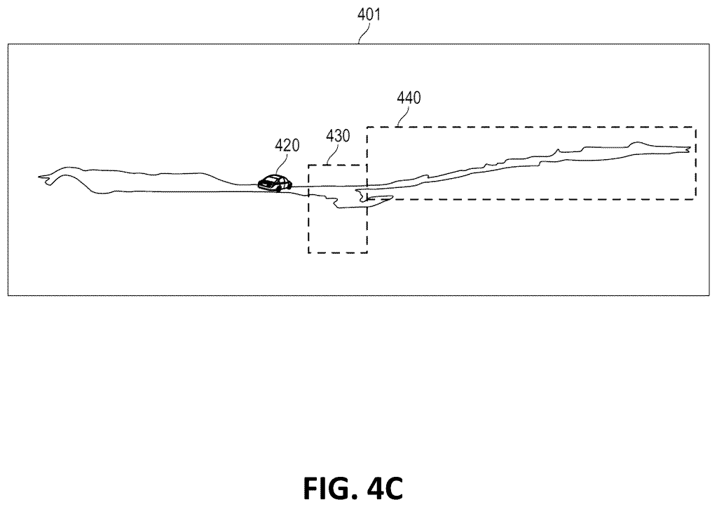

After applying deconvolution to the image data (that has been featurized, transformed, and the timestamp fused), the method 200 may then apply various trained AI modeling techniques discussed herein (e.g., FIGS. 3-4) to generate volume outputs (step 260). The volume output may include binary data for different voxels indicating whether a particular voxel is occupied by an object having mass. Specifically, the volume output may include occupancy data, including binary data, indicating whether a voxel is occupied and/or occupancy flow data indicating how fast (if at all) the voxel is moving (velocity being calculated using the temporal alignment).

The volume output may also include shape information (the shape of the mass occupying the voxel). In some embodiments, the size of each voxel may be predetermined, though the size may be revised to produce more granular results. For instance, the default size of different voxels may be 33 centimeters (each vertex). While this size is generally acceptable for voxels, the results can be improved by reducing the size of the voxels. For instance, if a voxel is detected to be outside of the ego's driving surface, the 33 cm voxel may be appropriate. However, the analytics server may reduce the size of voxels (e.g., to 10 cm) that are occupied and within a threshold distance from the ego and/or the ego's driving surface. When the voxel occupancy data is identified, a regression model may be executed, such that the shape of the group of voxels is identified. For instance, a 33 cm voxel (that belongs to a curb) may be half occupied (e.g., only 16 cm of the voxel is occupied). The analytics server may use regression to determine how much of the voxel is occupied.

Additionally, or alternatively, the analytics server may decode a sub-voxel value to identify the shape of the sub-voxels (inside of an occupied voxel). For instance, if a voxel is half occupied, the analytics server may define a set of sub-voxels and use the methods discussed herein to identify volume outputs for the sub-voxels. When the sub-voxels are aggregated (back into the original voxel), the analytics server may determine a shape for the voxel. For instance, each voxel may have eight vertices. In some embodiments, each vertex can be analyzed separately using the methods discussed herein. As a result, any point within each vertex of the voxel can be queried separately. Therefore, in this “continuous resolution” approach, the analytics server may not define a size for the sub-voxel. In some embodiments, the analytics server may use a multi-variant interpolation (e.g., trilinear interpolation) protocol to estimate the occupancy status of each sub-voxel and/or any point within each vertex.

The volume output may also include 3D semantic data indicating the object occupying the voxel (or a group of voxels). The 3D semantic may indicate whether the voxel and/or a group of nearby voxels are occupied by a car, street curb, building, or other objects. The 3D semantic may also indicate whether the voxel is occupied by a static or moving mass. The 3D semantic data may be identified using various temporal attributes of the voxel. For instance, if a group of voxels is identified to be occupied by a mass, the collective shape of the voxels may indicate that the voxels belong to a vehicle. If, at a previous timestamp, the identified group of voxels (now known to be a vehicle) was identified as moving, then the group of voxels may have a 3D semantic indicating that the group of voxels belongs to a moving vehicle. In some embodiments, the analytics server may use the AI model(s) discussed herein and/or a separate model to classify and group the voxels together. For instance, if a group of voxels are identified as moving together (the group of voxels has consistent movement with consistent timestamps), the analytics server may classify the group of voxels as belonging to the same object. In some examples, if a set of voxels representing different parts of a vehicle, such as its hood, roof, and trunk, all move at the same rate and in the same direction, the AI model(s) may recognize this pattern, and classify the group of voxels as a single entity. The analytics server may leverage additional motion consistency checks, such as acceleration continuity or spatial cohesion, to further validate the grouping. In another example, if a group of voxels are identified to have a shape corresponding to a curb and are not identified as having any movements, the group of voxels may have a 3D semantic indicating a static curb.

In some embodiments, certain shapes or 3D semantics may be prioritized. For instance, certain objects, such as other vehicles on the road or objects associated with driving surfaces (e.g., curbs indicating the outer limits of the road) may be thoroughly analyzed. In contrast, details of static objects, such as a building nearby that is far from the ego's driving surface, may not be analyzed as thoroughly as a moving vehicle near the ego. In some embodiments, certain objects having a particular size or shape may be ignored. For instance, road debris may not be analyzed as much as a moving vehicle near the ego. In some embodiments, the analytics server may selectively exclude certain voxels from analysis when processing the ego's surrounding environment, particularly for objects deemed irrelevant or non-impactful to autonomous driving decisions. For instance, voxels corresponding to small debris, such as leaves or pebbles, may be detected by the AI model but disregarded when generating the occupancy grid, as their presence does not meaningfully alter the ego's navigation path. By filtering out these low-priority voxels, the computational efficiencies can be created that enhance decision-making by focusing on critical elements that influence driving behavior.

In some embodiments, an object-level detection may not need to be performed by the method 200. For instance, the ego must navigate around to avoid a voxel in front of the ego that has been identified as static and occupied, regardless of whether the voxel belongs to another vehicle, a pedestrian, or a traffic sign. Therefore, the occupancy information may be object-agnostic. In some embodiments, an object detection model may be executed separately (e.g., in parallel) that can detect the objects that correspond to various groups of voxels.

At step 270, the method 200 may generate a query-able dataset that allows other software modules to query the occupancy statuses of different voxels. For instance, a software module may transmit coordinate values (X, Y, and Z axis) of the ego's surroundings and may receive any of the four categories of occupancy data generated using the method 200 (e.g., volume output). The query-able dataset may be used to generate an occupancy map (e.g., FIGS. 3A-B) or may be used to make autonomous navigation decisions for the ego.

Additionally, or alternatively, the analytics server may generate a map corresponding to the predicted occupancy status of different voxels. In a non-limiting example, the analytics server may use a multi-view 3D reconstruction protocol to visualize each voxel and its occupancy status. A non-limiting example of the map or occupancy map is presented in FIGS. 3A-B (e.g., a simulation 350). In some embodiments, the simulation 350 may be displayed on a user interface of an ego. The simulation 350 may illustrate camera feeds 300 depicted in FIG. 3A. The camera feeds 300 represent image data received from eight different cameras of an ego (whether in real-time or near real-time). Specifically, the camera feed 300 may include camera feeds 310a-c received from three different front-facing cameras of the ego; camera feeds 320a-b received from two different right-side-facing cameras of the ego; camera feeds 330a-b received from two different left-side-facing cameras of the ego; and camera feed 340 received from a rear-facing camera of the ego.

Using the methods discussed herein, the analytics server may analyze the camera feeds 300, divide the space surrounding the ego into voxels, and generate the simulation 350 (depicted in FIG. 3B) that is a graphical representation of the ego's surrounding. The simulation 350 may include a simulated ego (360) and its surrounding voxels. For instance, the simulation 350 may include a graphical indicator for different masses occupying different voxels surrounding the simulated ego 360. For instance, the simulation 350 may include simulated masses 370a-c.

Each simulated mass 370a-c may represent an object depicted within the camera feeds 300. For instance, the simulated mass 370a corresponds to a mass 380a (vehicle); the simulated mass 370b corresponds to a mass 380b (vehicle); and the simulated mass 370c may correspond to a mass 380c (buildings near the road). As depicted, every simulated mass includes various voxels. Moreover, the voxels depicted within the simulation 350 may have distinct graphical/visual characteristics that correspond to their volume outputs (e.g., occupancy data). For instance, the simulated mass 370c (e.g., a building) may have a first color indicating that it has been identified as static. Likewise, simulated mass 370b (e.g., a vehicle) may have a second color indicating that it is a parked or stationary vehicle. In contrast, simulated mass 370a (e.g., another vehicle) may have a third color and/or other visual characteristics indicating that it is predicted to be moving.

Additionally, or alternatively, the analytics server may transmit the generated map to a downstream software application or another server. The predicted results may be further analyzed and used in various models and/or algorithms to perform various actions. For instance, a software model or a processor associated with the autonomous navigation system of the ego may receive the occupancy data predicted by the trained AI model, according to which navigational decisions may be made.

FIG. 2B illustrates a flow diagram of a method 201 executed in an AI-enabled visual data analysis system, according to embodiments. The method 201 may include steps 210-290. However, other embodiments may include additional or alternative steps or may omit one or more steps altogether. The method 201 is described as being executed by an analytics server (e.g., a computer similar to the analytics server 110a). However, one or more steps of the method 201 may be executed by any number of computing devices operating in the distributed computing system described in FIGS. 1A-C (e.g., a processor of the ego 140 and/or ego computing devices 141). For instance, one or more computing devices of an ego may locally perform some or all of the steps described in FIG. 2B.

Using the method 201, an AI model may be configured to produce more than an orthogonal projection of the ego's surroundings. The AI model may only need image data to predict various surfaces near an ego and their corresponding surface attributes. As depicted, the method 201 includes volume outputs (step 260) that indicate surface attributes of different volumes surrounding the ego.

As depicted the steps 210-250 may be similar in the FIG. 2A and FIG. 2B. However, the method 201 may include additional steps that allow the AI model to predict attributes of surfaces surrounding an ego. Specifically, the method 201 may include an additional step 280 in which the ground truth is generated and additional step 290 with which a 3D representation (e.g., model rendering) of the ego's surroundings is generated using the data predicted via executing the methods 200 and 201.

Instead of generating an orthographic view of the ego's surroundings, the method 201 allows an AI model to predict 3D attributes of various surfaces in an environment surrounding the ego. Using the method 201, the ego may no longer be required to be localized in order to achieve autonomous navigation. In contrast to conventional methods, the method 201 can allow an AI model to receive image data and analyze various surfaces near the ego in real-time or near real-time (on the fly). As a result, the ego may be able to navigate itself without executing a localization protocol.

The images received from the ego's cameras may include a 2D representation of the ego's surroundings. This representation is sometimes referred to as a 2D or flat lattice. The flat lattice may be transformed into different nodes having particular X-axis and Y-axis coordinate values. Using the method 201, the AI model may predict a Z-axis coordinate value for each node within the flat lattice. Specifically, using the method 201, the AI model may predict a feature vector for each point within image data having distinct X-axis and Y-axis coordinate values. As used herein, Z-axis coordinate values for each point or node may represent that point's elevation relative to a flat surface having a 0 elevation in the world.

In addition to predicting an elevation for each node, the AI model may also determine a category for each node (surface attribute). For instance, the AI model may determine whether a surface is navigable. Additionally, the AI model may determine an attribute of each surface's material (e.g., grass, dirt, asphalt, or concrete). Additionally, the AI model may determine whether the surface is a road or a sidewalk. Moreover, the AI model may determine paint lines associated with different surfaces, allowing the AI model to deduce whether a surface is a road surface or a curb.

Using the feature vectors for each node, the AI model may generate a mesh representation that corresponds to the ego's surroundings. A mesh, as used herein, may refer to a series of interconnected nodes representing the ego's surroundings where each node includes X, Y, and Z-axis coordinate values. Each node may also include data indicating its attributes and categories (e.g., whether the node within the surface is navigable, what the node is identified to be, and what material the node is predicted to be).

At step 280, the AI model may generate ground truth to be ingested by the deconvolution step (250). The sensors of the ego may generate a point cloud of the ego's surroundings. The point cloud may include numerous points that represent 3D coordination data associated with the ego's surroundings at different timestamps. In a non-limiting example, LiDAR data may be received from an ego and the point cloud may represent the LiDAR data points received. The cameras of the ego may also transmit images of the ego's surroundings at different timestamps. The analytics server may use different timestamps to identify image data corresponding to different points within the point cloud. The analytics server may then project the data associated with the points within the image data, thereby identifying a region of the image (having a set of pixels) that corresponds to one or more points within the point cloud.

Additionally, or alternatively, instead of using LiDAR data, the analytics server may use image data captured by one or more cameras of the ego. Using the captured image data, a point cloud can also be generated, e.g., by triangulating salient feature points detected within the image data.

The analytics server may also use a secondary AI model (e.g., neural network), such as a semantic segmentation network to analyze the pixels within the image data. For instance, a group of pixels may be analyzed by the semantic segmentation network. The semantic segmentation network may then determine one or more attributes of the set of pixels. For instance, using this paradigm, the analytics server may determine whether a group of pixels corresponds to a tree, sky, curb, or road. In some embodiments, the semantic segmentation network may determine whether a surface is navigable or not. In some embodiments, the semantic segmentation network may determine a material associated with a set of pixels. For instance, the semantic segmentation model may determine whether a pixel within the image data corresponds to dirt, water, concrete, or asphalt. In some other embodiments, the semantic segmentation network may identify whether a surface is painted; and if so, the color of the paint. Essentially, the semantics of each 3D point can be identified using the semantic segmentation network.

Using the semantic segmentation model, the analytics server may filter down the points and cluster them into their respective category (e.g., pixels that represent a sidewalk, pixels that represent a dirt road or an asphalt road). The analytics server may analyze different image data at different timestamps.

After executing the semantic segmentation model, the point cloud may be segmented in accordance with their corresponding image data and/or their attributes (as predicted by the semantic segmentation model). As a result, points relevant to a particular surface and the image data relevant to the same surface surrounding the ego may be identified and isolated. The analytics server may then fit a mesh surface on the isolated data points. This may be because the AI model may execute more efficiently using a smoothed surface, which may be more indicative of the reality. Effectively, the mesh fitting may de-noise the data and provide a more realistic representation of the surfaces surrounding the ego. The fitted surface may be used as ground truth for training purposes.

The AI model may be trained using the image data received from the egos and the ground truth, such that, when trained, the AI model may not need any sensor data (e.g., radar, LiDAR, or other 3D sensor) to analyze the image data received from an ego. Effectively, using this particular training paradigm, the AI model may correlate how pixels associated with a particular surface having particular attributes (e.g., uphill dirt road having white paint) are represented. Therefore, the AI model (at inference time) may only utilize image data and not need other sensor data.

Once trained, the AI model may be configured to ingest image data and generate a lattice having various nodes where each node has a respective feature vector including X and Y-axis coordinate values (identified via the image data) and a Z-axis coordinate value predicted by the AI model. The AI model may also predict one or more attributes for each node. For instance, a particular node may include a feature vector that includes a predicted elevation (e.g., 1 meter above ego). Additionally, the AI model may predict that the node is a road node (because the corresponding pixel is predicted to be a driving surface) and the node has paint on it and the paint is yellow. The AI model may segment and classify painted regions (e.g., on the street) and use the paint on the street to distinguish lane demarcations from other road markings based on predefined characteristics, such as width, curvature, and continuity. Additionally, the model may recognize specific colors and patterns—such as white or yellow solid and dashed lines for lane boundaries or blue markings for designated parking areas—to infer traffic rules and permissible vehicle positioning/parking. For instance, using the color of a painted line, the analytics server may determine that a parking spot is designated as a handicapped parking spot. In another example, a red color of a curb may indicate a fire lane, which restricts parking.

In some embodiments, the coordinate values (e.g., Z-axis coordinates indicating the elevation of a node) may need to be adjusted because the ego itself has changed positions and the Z coordinates may not be revised. For instance, when an ego is navigating through a terrain, it can transmit coordinates of its surroundings. However, the coordinates may be relative to the ego's sensors or the ego itself. Therefore, if the ego changes its vertical position (e.g., if the ego is driving over a speed bump or a pothole), the coordinates received from the ego may change too. However, the coordinates may change because they are relative to the ego's coordinates. For instance, the same location may have different coordinate values if the ego is driving on a flat surface versus when the same ego is driving over a speed bump. Therefore, in some embodiments, the coordinates received from the ego may be revised before they can be used to train the AI model.

In order to rectify this issue, the coordinate values may be aligned with the surface of the ego's surrounding itself (instead of the ego). In this way, noisy or incorrect data received as a result of the ego's movements can be smoothed out. Essentially, the surface is treated independently, and the coordinate values are calculated (and ultimately predicted) in accordance with the surface and not the ego.

In some embodiments, the method 201 can be combined with the method 200 (occupancy detection paradigm) in order to identify objects located within elevated surfaces. For instance, an object may be detected on a surface that is already identified as having a higher or lower elevation than the ego (e.g., a traffic cone is identified on a hill in front of the ego). In this example, the AI model may use the method 201 to determine attributes of the hill in front of the ego. Then the attributes of the cone itself may be identified as if the cone was located on a flat surface (e.g., the height of the hill at that particular location can be subtracted). Then the AI model may use the method 200 to identify the voxels associated with the cone, such that the cone's dimensions are identified. The dimensions are then added to the hill as identified using the method 201. Therefore, the AI model may bifurcate the identification of surfaces and objects and then combine them to truly understand/predict the position and attributes of different objects located on different surfaces.

Bifurcating the detection into two different protocols (methods 200 and 201) also allows an ego to detect the occupancy status of different voxels when they are outside the ego's occupancy detection range. For instance, an ego may have a vertical occupancy detection range of −3 meters to +3 meters. This indicates that the ego can identify an occupancy status of different voxels if they are located within −3 meter to +3-meter elevation of the ego. The occupancy detection range may not mean that the camera cannot record footage of objects outside the range; in contrast, it may mean that objects outside the detection range cannot be identified using an AI model.

In those embodiments, the ego may not be able to predict any objects located on a steep hill that is located outside of the ego's occupancy detection range (e.g., a traffic cone that is on a downhill with −4-meter elevation relative to the ego). Using the methods discussed herein, the ego may first determine that the driving surface is −4 meter lower than the ego. The AI model may then determine the attribute of the voxels occupying the space (the traffic cone) separately and subtract the height of the hill from the height of the traffic cone. This adjustment may allow the traffic cone to be correctly placed within the 3D environment surrounding the ego despite being detected from an elevated perspective. By applying similar corrections for terrain variations, the method 201 may effectively extend its occupancy detection range to include areas that are not at the same elevation as the ego, enhancing spatial awareness and object classification across varying terrain heights.

Using the method 201, the AI model may receive image data from an ego's cameras and transform the image data into a mesh representation of the ego's surroundings. Therefore, the images received from the cameras can be transformed into a 3D description of the surfaces surrounding the ego, such as the driving surface.

In some embodiments, the analytics server may use a neural radiance field (NeRF) technique to recreate a rendering of the ego's surroundings (step 290). In some embodiments, the analytics server may generate a map that indicates various surfaces surrounding the ego using the image data captured. The map may correspond to the predicted surfaces and their predicted attributes. In a non-limiting example, the analytics server may use a multi-view 3D reconstruction protocol to visualize each voxel and its surface status/attribute. A non-limiting example of the map or the surface map is presented in FIGS. 4A-C (e.g., a simulation 400).

In some embodiments, the simulation 400 may be displayed on a user interface of an ego. The simulation 400 may illustrate how camera feeds 410 can be analyzed to generate a graphical representation of an ego's surroundings. The camera feeds 410 represent image data received from five different cameras of an ego (whether in real-time or near real-time). Each camera feed may be received from a different camera and may depict a different view/angle of the ego's surroundings. Specifically, the camera feeds 410 represent image data received from eight different cameras of an ego (whether in real-time or near real-time). The camera feed 410 may include camera feeds 410a-c received from three different front-facing cameras of the ego; camera feeds 410d-e received from two different right-side-facing cameras of the ego; camera feeds 410f-g received from two different left-side-facing cameras of the ego; and camera feed 410h received from a rear-facing camera of the ego.

Using the methods discussed herein, the analytics server may analyze the camera feeds 410-450 and generate the simulation 400 that is a graphical representation of the ego's surrounding surfaces. The simulation 400 may include a simulated ego (420) and its surrounding surfaces. For instance, the simulation 400 may visually identify the surfaces 430 and 440 using a visual attribute, such as a distinct color (or other visual methods, such as hatch patterns) to indicate that the AI model has identified the surfaces 430 and 440 to be navigable surfaces. The simulation 400 may also include a surface 450 and 492, which are visually distinct (e.g., different color or different hatch patterns) than the surfaces 430 and 440 because the surfaces 450-460 have been identified as curbs, which are not navigable surfaces.

Different surfaces depicted within the simulation 400 may visually replicate a predicted elevation (e.g., predicted Z coordinate values using the AI model). For instance, the surface 430 (in front of the ego) visually indicates that the road ahead of the ego is a downhill road. In contrast, the surface 440 is visually depicted as an uphill road.

Referring now to FIG. 4C, a simulation 401 depicts the same surfaces depicted within the simulation 400. Specifically, the simulation 401 includes the simulated ego 420 driving on the surface 430 (the same surface 430 depicted within the simulation 400) and the surface 440 to the right of the simulated ego 420.

Additionally, or alternatively, the analytics server may transmit the generated map to a downstream software application or another server. The predicted results may be further analyzed and used in various models and/or algorithms to perform various actions. For instance, a software module or a processor associated with the autonomous navigation of the ego may receive the occupancy data predicted by the trained AI model where various navigational decisions may be made accordingly.

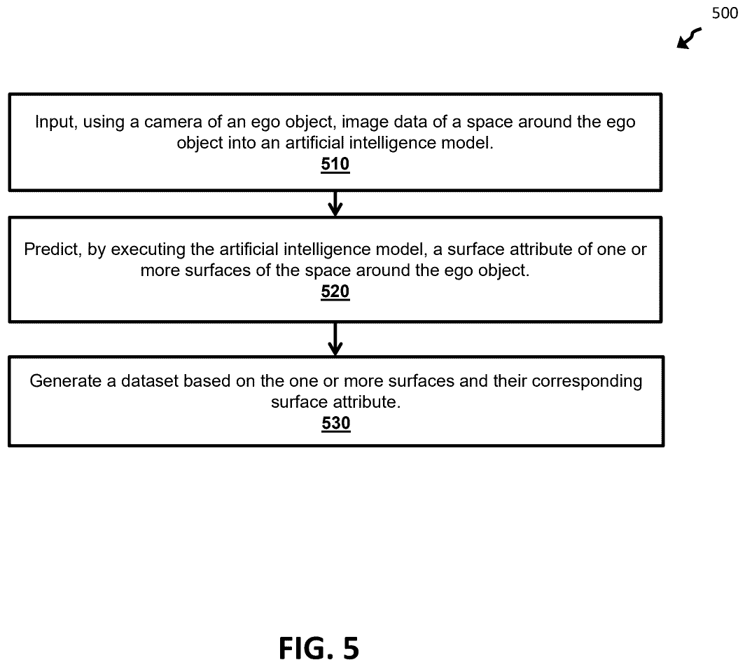

FIG. 5 illustrates a flow diagram of a method 500 executed in an AI-enabled visual data analysis system, according to embodiments. The method 500 may include steps 510-530. However, other embodiments may include additional or alternative steps or may omit one or more steps altogether. The method 500 is described as being executed by an analytics server (e.g., a computer similar to the analytics server 110a). However, one or more steps of the method 500 may be executed by any number of computing devices operating in the distributed computing system described in FIGS. 1A and 1B (e.g., a processor of the egos 140 and/or egos computing device 141). For instance, one or more computing devices may locally perform some or all of the steps described in FIG. 5. For instance, a chip placed within an ego may perform the method 500.

At step 510, the analytics server may input, using a camera of an ego object, image data of a space around the ego object into an artificial intelligence model. The analytics server may collect and/or analyze data received from various cameras of an ego (e.g., exterior-facing cameras). In another example, the analytics server may collect, and aggregate footage recorded by one or more cameras of the ego. The analytics server may then transmit the footage to the AI model trained using the methods discussed herein.

At step 520, the analytics server may predict, by executing the artificial intelligence model, a surface attribute of one or more surfaces of the space around the ego object. The AI model may use the methods discussed herein to identify one or more surfaces surrounding the ego. The AI model may also predict one or more surface attributes (e.g., category, material, elevation) for the one or more surfaces using the data received in the step 710.

At step 530, the analytics server may generate a dataset based on the one or more surfaces and their corresponding surface attribute. The analytics server may generate a dataset that includes the one or more surfaces and their corresponding surface attributes. The dataset may be a queryable dataset available to transmit the predicted surface data occupancy status to different software modules.

Using the methods and systems discussed herein, a processor associated with an ego can voxelize an ego's surroundings and determine whether different voxels are occupied via an object. The processor can also determine various surfaces of the objects occupying the voxels within the space surrounding the ego. However, in some autonomous driving embodiments, such as parking the ego or when the ego is located within a more confined space, the ego may need a more refined/granular understanding of its surroundings. Using conventional approaches or off-the-shelf systems faces technical challenges and limitations in accurately predicting the distance between an ego and various objects within its surroundings. These conventional solutions may often result in imprecise representations of the ego's surroundings as they struggle to capture the fine details and spatial nuances necessary for precise navigation, such as the need for assisted parking applications.

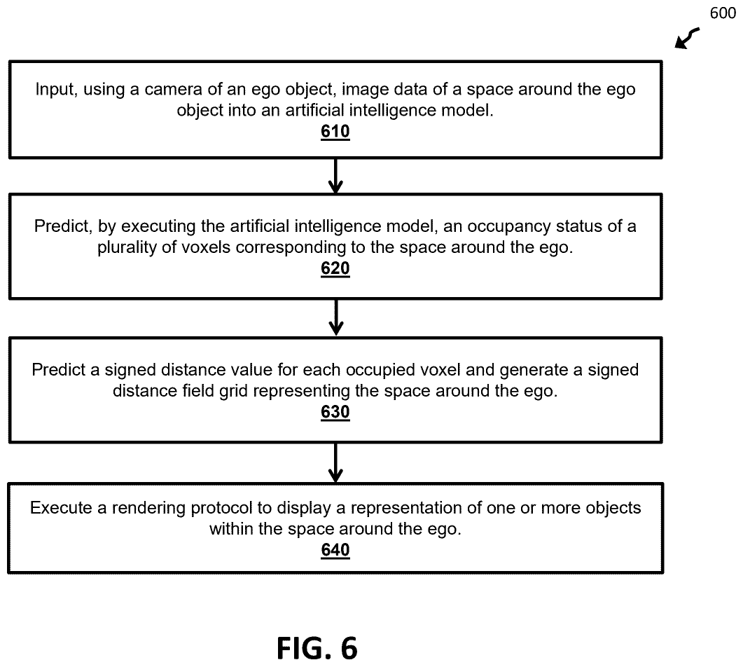

FIG. 6 illustrates a flow diagram of a method 600 executed in an AI-enabled visual data analysis system, according to embodiments. The method 600 may include steps 610-640. However, other embodiments may include additional or alternative steps or may omit one or more steps altogether. The method 600 is described as being executed by an analytics server (e.g., a computer similar to the analytics server 110a). However, one or more steps of the method 600 may be executed by any number of computing devices operating in the distributed computing system described in FIGS. 1A and 1B (e.g., a processor of the egos 140 and/or egos computing device 141). For instance, one or more computing devices may locally perform some or all of the steps described in FIG. 6. For instance, a processor placed within an ego may perform the method 600.

The methods and systems discussed herein can be implemented in various autonomous driving services, such as assisted parking applications or other software solutions. Using the method discussed in FIG. 6, a processor (e.g., the analytics server) can predict the signed distances associated with various objects occupying different voxels. The analytics server can use the AI models discussed herein to calculate the distance between an occupied voxel and another occupied voxel (e.g., the surface of another object or the same object) within the ego's 3D environment. Using the AI models discussed herein, instead of conventional methods or generic shape detection models, allows for finer shape refinement and improved spatial awareness. Through continuous value prediction for each voxel, the processor can determine occupancy and the precise distance to nearby objects for each voxel, enabling a more detailed and accurate representation of the ego's surroundings.

Method 600 can be implemented using only 2D cameras by leveraging AI-driven visual perception techniques to infer spatial relationships and scene structure without requiring depth sensors, time of flight sensors, radars, or LiDAR. In some embodiments, the one or more processors discussed herein may process sequential 2D image frames to detect and track objects, estimate motion, and construct a voxel-based occupancy representation using learned features from neural networks trained on vision data.

The AI models discussed herein can be customized and specially trained so that the results can be calculated in real-time or near real-time without the need for any data other than those provided by the ego's one or more cameras. Specifically, the method 600 can be performed using camera data only. In some embodiments, other sensor data can be analyzed. However, the AI models discussed herein may reach operational status only by ingesting a camera feed and may not need additional data.

The output of the models discussed herein can then be ingested by a rendering engine. Using the rendering techniques discussed herein, a high-fidelity and high-quality representation of the space surrounding the ego can be rendered in real-time or near-real-time. The rendering protocols utilized to translate the continuous values into visual representations can be executed locally at an ego or via any processor associated with the ego, such that the representation can be presented to the driver/passengers of the ego. In some embodiments, by stacking 2D images generated from different layers of the signed distance field grid, a 3D approximation of the ego's environment can be achieved, offering a smooth and realistic depiction of the space surrounding the ego. This rendering technique, combined with the ability to predict paint markings on the ground, enhances the visualization of the ego's surroundings, facilitating other applications, such as assisted parking applications, with greater precision.

At step 610, the analytics server may input, using a camera of an ego object, image data of a space around the ego object into an artificial intelligence model. The analytics server may collect and/or analyze data received from various cameras of an ego (e.g., exterior-facing cameras). In another example, the analytics server may collect, and aggregate footage recorded by one or more ego cameras. The analytics server may then transmit the footage to the AI model trained using the methods discussed herein.

At step 620, the analytics server may predict, by executing the artificial intelligence model, an occupancy status of a plurality of voxels corresponding to the space around the ego. The AI model may first determine the occupancy status of the vehicles and/or surface information for the voxels, as discussed in FIGS. 2A-5.

At step 630, the analytics server may predict a signed distance value for each occupied voxel and generate a signed distance field grid representing the space around the ego. The AI model may predict the signed distance for different occupied voxels via the camera feed by leveraging advanced neural network architectures. In some embodiments, the AI model may utilize deep learning techniques to predict the signed distances from the visual data received (e.g., camera feed). The AI model may have been previously trained on large datasets of camera images paired with corresponding ground truth depth maps. Through this training process, the AI model may learn how to infer the signed distance of different voxels based on visual cues such as object edges, textures, perspective, and the like. Specifically, the AI model may extract visual features from the camera feed received and then utilize regression techniques (or other techniques) to estimate the signed distance to objects.

As used herein, the signed distance may refer to the distance between an occupied voxel and the closest occupied voxel (or a distance to the nearest surface). That is, the signed distance may refer to how far an occupied voxel is from its nearest object (surfaces of the object). Therefore, the signed distance may not correspond to the distance between an object and the ego. Because the signed distance can be predicted in exact numbers (as opposed to whole integers or binary indication of whether a voxel is occupied), the signed distances are suitable for granular and detailed visualization.

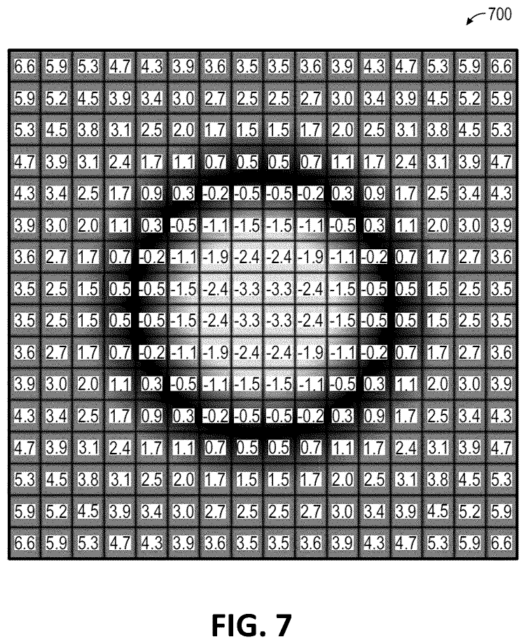

Once different signed distance values for different voxels are calculated, the analytics server may aggregate the values and generate a signed distance field grid. Referring now to FIG. 7, a non-limiting example of a signed distance field grid is depicted. A signed distance field grid may be a data structure that represents spatial information about objects within an ego's environment as predicted by the AI model. As depicted in FIG. 7, each grid cell may contain a value representing the distance from that cell to the nearest object surface (e.g., occupied voxel), with positive values indicating distances outside the object and negative values indicating distances inside the object. In some embodiments, a signed distance field representation, each cell (or voxel) typically has a single signed distance value, which indicates the shortest distance to the closest surface or occupied voxel. The signed distance may encode a single signed distance at each point/cell, allowing the model to infer whether the point is inside or outside the object. Moreover, the sign convention may follow that negative values indicate the interior of an object, while positive values indicate the exterior. However, in some embodiments, the sign may indicate a direction associated with the distance.

The signed distance field grid 700 includes different cells (corresponding to different voxels within an ego's environment/space). Specifically, the signed distance field grid 700 represents a circle. Therefore, each positive value may represent how far each position/cell is from the surface of the circle, and each negative value may represent how far inside the circle each position/cell is located. Though the signed distance field grid 700 depicts one object (the circle in the middle), multiple objects can be shown using a single grid. Moreover, this approach allows for the representation of non-arbitrary shapes. Additionally, the grid-based representation allows for efficient storage and processing of spatial information, making it useful for various autonomous driving tasks. Finally, having the grid allows for the prediction or interpolation of a continuous value that corresponds to various surfaces (especially when the surface does not belong to an arbitrary shape). In this way, a smooth surface can be achieved.

Training the AI model

The analytics server may first train the AI model discussed herein such that the AI model can predict the signed distance using only visual data (e.g., camera feed). Training the AI model may involve several steps to ensure it can accurately predict the signed distance via the camera feed. Many of the steps necessary to train the AI model may be similar to the training discussed with respect to the occupancy network generation, as discussed with respect to FIGS. 2A-B.

In some embodiments, a training dataset comprising camera images paired with corresponding ground truth depth maps may be generated and used to train the AI model. The camera images may be captured from various scenes and perspectives (e.g., from different cameras of an ego) as the ego is driving through different scenarios and different routes. Therefore, the collected data may encompass diverse real-world and/or enclosed controlled environments footage of one or more egos driving through different courses. The ground truth depth maps may provide accurate distance information for objects in the scene, serving as the target output for the AI model to learn from during training. Using the camera footage and the known distances, the AI model may be trained so that the AI model can receive new camera footage of a new ego and predict the distances accordingly.

In a non-limiting example, the analytics server may receive a camera feed of one or more egos navigating different routes. The routes may be pre-determined or pre-defined, such that information collected can be eventually used in light of known metrics and parameters.

In some embodiments, the analytics server may then pre-process the collected data and prepare the data for training purposes. Preprocessing steps may include resizing images to a uniform resolution, normalizing pixel values to a common scale, and augmenting the dataset with transformations such as rotation, scaling, and flipping to enhance the AI model's robustness and generalization ability.

The analytics server may also post-process the data and determine actual distances for the navigation sessions of the ego so that the AI model can be trained. For instance, the analytics server may post-process the data and calculate sign distances associated with the navigational sessions (e.g., as the ego is driving through the route, all signed distances to various surfaces of different objects can be calculated). This step may sometimes be performed offline in order to reduce the computing resources used and/or increase accuracy.

In order to calculate the distances, the analytics may use one or more of several techniques. In some embodiments, the analytics server may use a simulation technique to determine the signed distances. For instance, the route being driven by the vehicle can be controlled or pre-defined, such that all distances are already known. As the vehicle navigates through the known course, the analytics server may simulate what the readings and the data received “should be” by analyzing the known course and simulating the ego's navigation. As a result, the analytics server may calculate the results.

Additionally, or alternatively, the ego may be equipped with sensors in addition to or instead of a camera, which may be utilized for the purposes of training. The analytics server may then collect the sensor data received and calculate the sign distances. Using a timestamp associated with the camera feed and the sensor data received, the analytics server may match the distances to their corresponding visual attribute (e.g., synchronize the camera feed to the sensor data received).

Additionally, or alternatively, the analytics server may use a variety of techniques to analyze the image (offline) to calculate the distances. For instance, the analytics server may reconstruct the environment (e.g., the space around the vehicle) using the camera feed and then use the reconstructed environment to determine the distances. In some embodiments, the analytics server may analyze the disparities between corresponding points in the images (e.g., different feeds received from different cameras of the vehicle as the vehicle is driving through the course), and the analytics server may triangulate and estimate the distance to objects in the scene.

Additionally, or alternatively, monocular depth estimation techniques can be utilized in which a single camera feed can be used to infer depth information. In some other embodiments, a deep learning model trained on extensive datasets can be employed offline to predict depth maps or signed distance fields directly from 2D or 3D images.

Once the distances are calculated, the distances (as they correspond to the camera feed captured from the vehicle) can be added to the training dataset. Therefore, the training dataset may include a camera feed of each vehicle (captured via different cameras) and a depth/sign distance chart of the same drive or navigation session.

The analytics server may train an AI model using the training dataset, whereby the AI model correlates each data point within the camera feed to a corresponding distance that is known to be accurate to train itself. Once trained, the AI model may be configured to receive a camera feed from a new ego and predict signed distances of various occupied voxels within the ego's environment.

Using this training method, the AI model may correlate different visual attributes of a voxel (within the camera feed within the second dataset) to an occupancy status of that voxel and its respective signed distance. In this way, once trained, the AI model may receive a camera feed without receiving sensor data and then determine each voxel's occupancy status and a corresponding signed distance value.

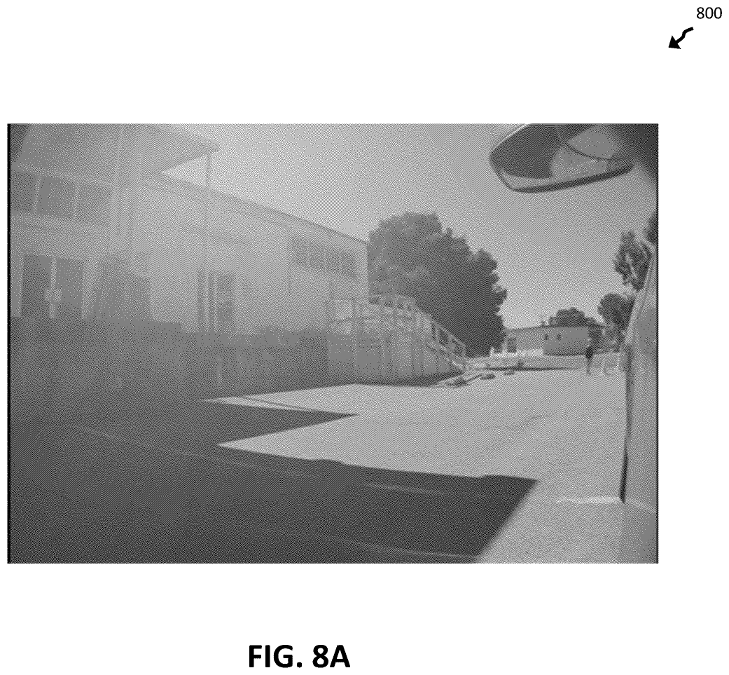

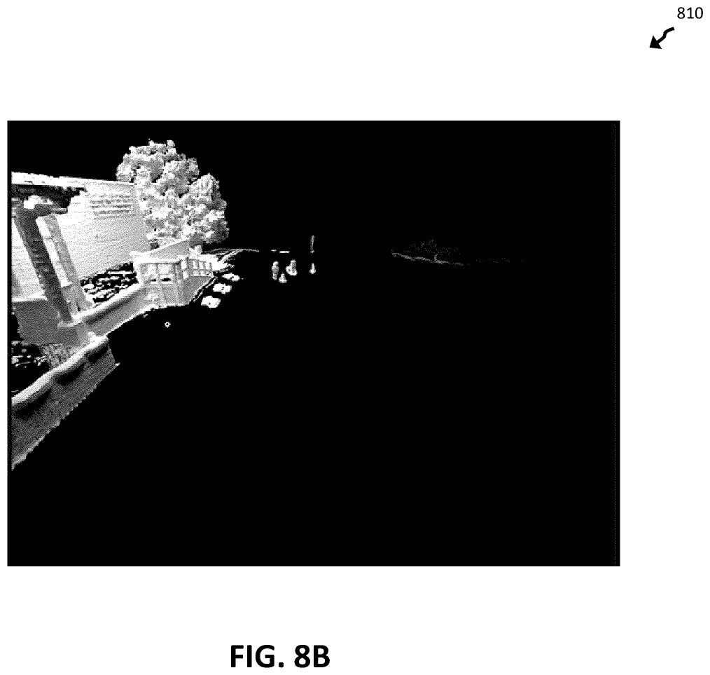

After training, the AI model may be configured to receive a camera feed of an ego and generate a signed distance field grid representing the ego's surroundings. For instance, as depicted in FIG. 8A, the AI model may receive only the camera feed 800. The AI model may analyze various features of one or more objects depicted within the camera feed 800. Using the camera feed only and without the need to use LiDAR or other sensor data, the AI model may determine the signed distance of various voxels. The AI model may then use the rendering methods discussed herein to render the environment representation 810 depicted in FIG. 8B.

In some embodiments, the signed distance field grid may not necessarily convey a distance to the ego itself because the signed distance values predicted using the AI model may represent each voxel's distance to a nearby surface (or otherwise occupied voxel) and not the ego. To identify the ego's relative location (e.g., to place the ego accurately within the reconstructed space that includes all the objects), the analytics server may employ one or more techniques. First, the AI model may be trained such that the camera feed is used to determine a distance to at least one voxel (e.g., the distance of the ego to the voxel). Once this distance is predicted, the signed distance field grid can be used to calculate all other distances, as the grid includes that voxel's signed distance to a nearby surface as well.

The analytics server may measure (using projected rays) how far one or more voxels are from the ego. The analytics server may instruct the ego to cast a projected ray from the camera into its surrounding environment. The analytics server may then analyze the path of the projected ray as it travels from the camera's viewpoint outward into the environment surrounding the ego. By casting a projected ray, the analytics server can determine what objects or surfaces the projected ray intersects with within the ego's environment. Using this data, the analytics server may determine the ego's precise distance to a nearby object. For instance, once the analytics server encounters an occupied voxel, it can determine its distance to the ego and then use the signed distance field grid to identify the relative distance of other surfaces/objects. Additionally, or alternatively, the analytics server may use a variety of localization techniques to predict the ego's location.

In some embodiments, a 2D camera can project a ray by simulating a virtual line extending from a pixel in the camera's image plane into the 3D environment surrounding the ego (e.g., the 3D environment that has been created of the ego's surroundings using the methods and systems discussed herein). The analytics server can compute this projection by leveraging the camera's intrinsic parameters (e.g., focal length, sensor size) and extrinsic parameters (e.g., position, orientation) to map each pixel to a corresponding projected ray. As the projected ray extends outward, the projected ray may intersect with one or more voxels in the signed distance field grid, allowing the system to determine whether the voxel is occupied by an object and, if so, estimate the distance from the ego to the object. By analyzing the sequence of ray intersections, the analytics server can refine its understanding of depth relationships, detect occlusions, and infer the structure of the surrounding space even without explicit depth data from specialized sensors like LiDAR or ToF cameras. This approach enables the ego to approximate spatial positioning using only 2D image data, facilitating object detection, localization, and environment mapping.

At step 640, the analytics server may execute a rendering protocol to display a representation of one or more objects within the space around the ego.

The analytics server may translate the signed distance into an image rendered on a computer associated with the ego. The analytics server may assume that a high (positive) signed distance value indicates that the corresponding voxel is away from the surface. In contrast, a negative signed distance value means that the voxel is “inside” the surface. When the value is equal to zero, the corresponding voxel is a part of the surface itself.

The analytics server may then assign a color to each voxel in accordance with its corresponding sign distance value. For instance, if a voxel is inside the surface (e.g., has a negative value), the analytics server may assign a colored layer (non-transparent) to that voxel. In contrast, if the voxel is outside the surface, the analytics server may assign a transparent value to that voxel. The analytics server may then generate a layer (2D layer) of the set of voxels where each voxel within that layer is either shown as transparent or colored. The analytics server may then iteratively generate subsequent layers until the layers can be aggregated (e.g., stacked on top of each other), and the space around the ego can be rendered.

Optionally, the analytics server may apply surface fitting and smoothing protocols to enhance the rendering of the ego's environment. The analytics server may utilize interpolation techniques or machine learning-based surface reconstruction methods to generate a continuous representation of object surfaces. By leveraging algorithms such as bicubic interpolation, spline fitting, or neural network-based surface completion, the analytics server can smooth out discontinuities and fill in missing data between sparse voxel points. This process may result in a more visually coherent and realistic depiction of the ego's surroundings, reducing jagged edges or artifacts that may arise from raw voxel-based representations.

In a non-limiting example, the analytics server may start from a vertical distance of 0 (from the surface of the road) and generate a layer where voxels with negative values are shown as dark, and the rest of the voxels are shown as transparent. The first layer may have a defined thickness, such as an inch or any other dimension. The analytics server may then generate a second layer that covers the vertical distance of 1 inch to 2 inches above the surface of the road. The analytics server may iteratively generate the layers until the ego's surroundings have been reconstructed. By aggregating (stacking) the 2D layers, the analytics server may achieve a 3D rendering of the objects within the space surrounding the ego. This rendering technique allows for precise reconstruction of the space surrounding the ego. Moreover, this rendering technique can be utilized such that the ego's environment is rendered in real-time or near real-time.

Additionally, or alternatively, the analytics server may cast a projected ray from a camera associated with the ego. The analytics server may then gauge the signed distance values along the casted projected ray. The analytics server may then render each intersected voxel depending on the signed distance values identified (along the projected ray). For instance, if a voxel has a positive value, it means that the voxel is away from surfaces, and it can be shown as transparent. In contrast, if the voxel has a negative value, it may need to be shown as colored.

These rendering techniques allow the analytics server to simulate what a camera would view/capture. As a result, a bird-eye-view of the ego can be reconstructed using the rendering techniques.

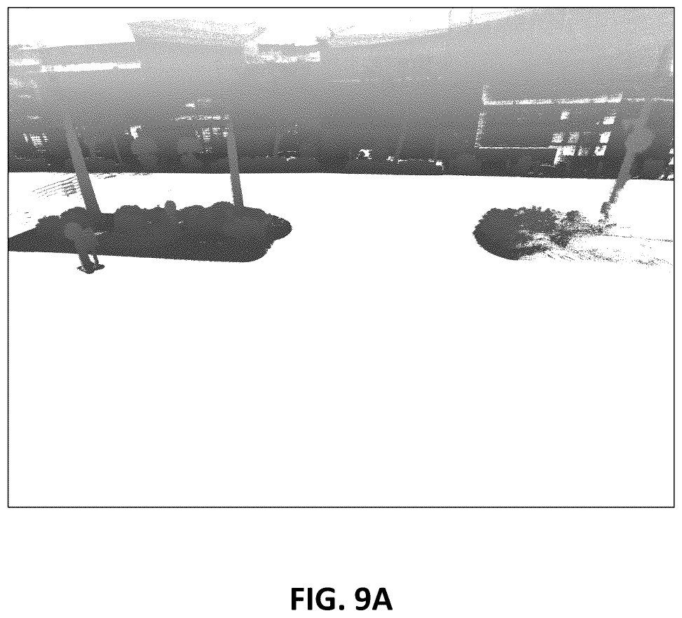

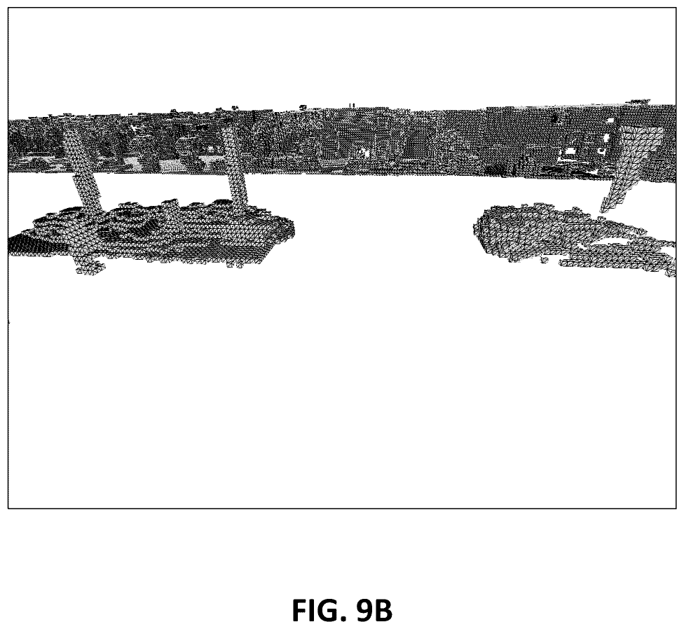

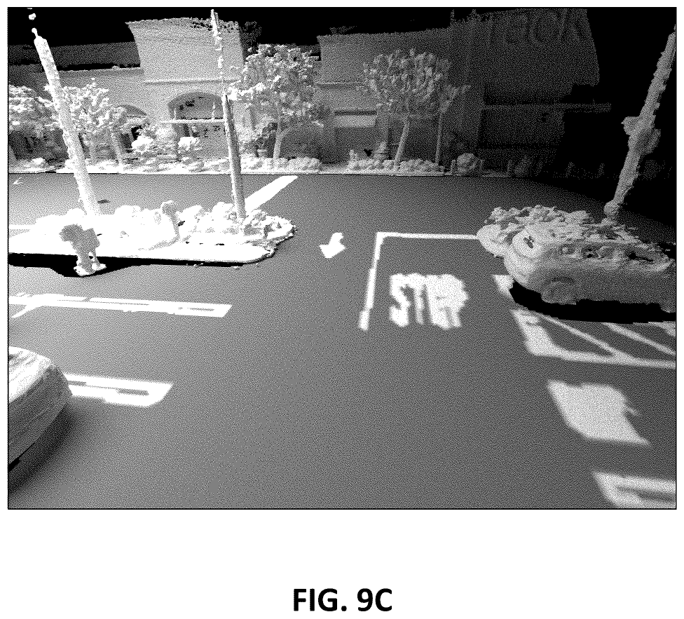

As discussed herein, the AI model's signed distance field grid calculation/prediction allows a rendering that is more realistic than using other conventional methods. For instance, FIGS. 9A-C depict the same environment being rendered where the FIG. 9A uses raw point cloud data points (e.g., data points achieved via a sensor or radar monitoring the ego's surroundings). As depicted, this is the rawest form of data (e.g., sensor data can be fed directly into the rendering engine). This method is memory intensive and hard to process/utilize for a processor for autonomous driving purposes, leading to noisy and unpredictable outcomes.

The same environment may be rendered using voxel occupancy data only, as depicted in FIG. 9B. While this representation is better than the point cloud method depicted in FIG. 9A, it does not include as many details as the one depicted in FIG. 9C (rendered using the signed distance calculations discussed herein). Moreover, as depicted in FIG. 9C, the AI model generates the representation of objects within the space. Therefore, the AI model may capture nuances within the space, which may eventually be used for navigating the ego through tight/small spaces.

In some embodiments, the analytics server may also train the AI model (or a separate model in some embodiments) to determine whether voxels associated with a driving surface include paint. The AI model may identify paint lines in a camera feed by processing the image data and analyzing features such as color, contrast, and texture. This process may involve segmenting the image into regions of interest and applying algorithms to detect patterns that resemble paint lines. The AI model may determine whether a voxel within a driving surface includes paint, as opposed to determining whether a line has been formed. As a result, non-arbitrary or non-continuous painted shapes can be identified.

In some embodiments, using deep learning techniques (e.g., convolutional neural network, transformer, etc.), the AI model may be trained to recognize complex patterns and structures in images. The analytics server may train the AI model using a training dataset containing examples of paint lines and another pattern (e.g., handicap parking, crosswalk, and the like), such that the AI model can ingest camera feed and distinguish between paint lines and other elements within the ego's surrounding space. In some embodiments, semantic segmentation techniques can be used in which different pixels are labeled during training in accordance with their respective category, allowing the computer to identify paint lines more accurately. By leveraging advanced image processing and machine learning techniques, the AI can effectively identify and localize paint lines in a camera feed, facilitating tasks such as autonomous driving and lane detection.

Because the AI model identifies the paint based on voxels and not conventional line detection techniques, the AI model's paint detection may not be restricted based on paint shape or granularity. For instance, some conventional models detect paint lines based on their corresponding shape (e.g., a continuous line of paint, such as the dividing line). Moreover, the paint detection may include detecting visual attributes of the painted voxel, such as thickness, shape, and color of the paint.

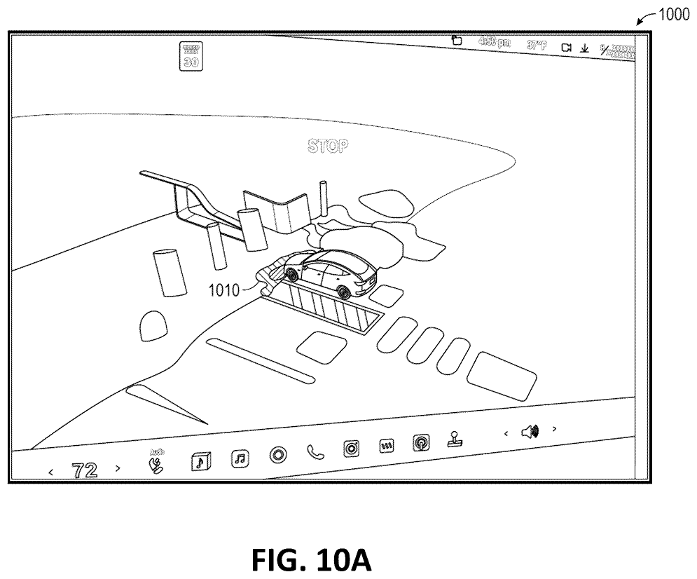

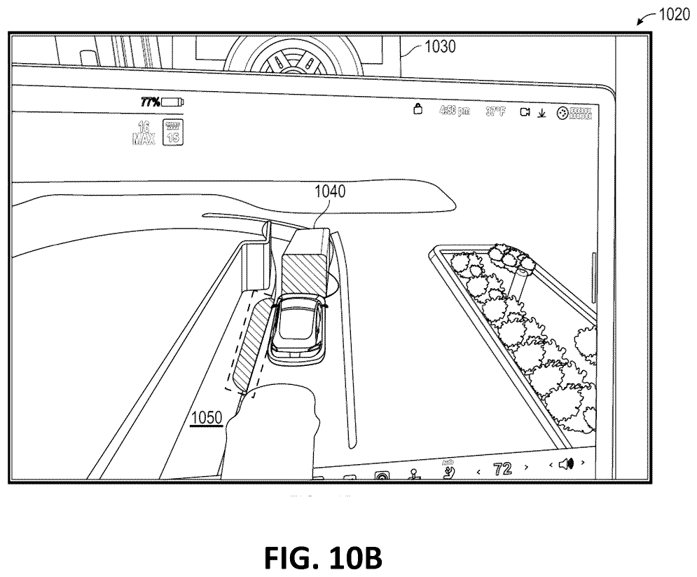

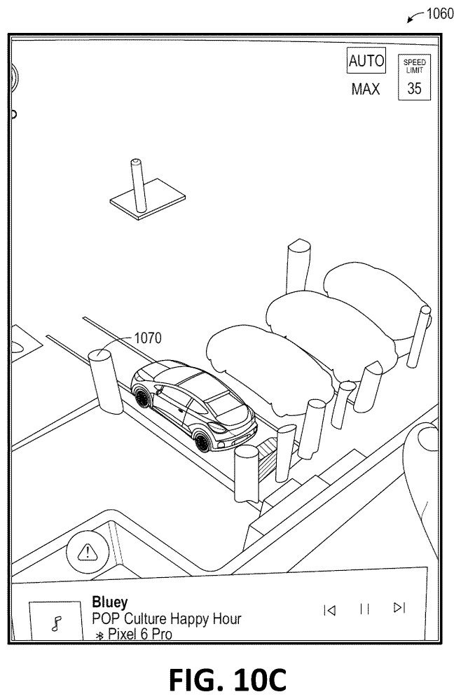

In some embodiments, the rendering of various voxels (and objects) may use visual attributes (e.g., different colors, hatch patterns, and/or shades) to indicate a relative distance of the objects to the ego identified using the methods and systems discussed herein. For instance, as depicted in FIG. 10A, the rendering of the ego's surroundings can be displayed on a monitor of the ego itself (interface 1000). As depicted, the interface 1000 displays the ego's surroundings, including various objects and paint lines. As depicted, the object in front of the ego can include visual attributes that allow for the driver/occupant of the ego to determine a relative distance of the object to the ego. In some embodiments, voxels closer to the ego (closer than a defined threshold or in a range) may be rendered in red, while other voxels (satisfying a second threshold indicating a medium distance away from the ego using another defined threshold or in a range) may be rendered as yellow.

In another example, an interface 1020 displayed on a monitor of an ego (depicted in FIG. 10B) may display a vehicle rendering 1040 that corresponds to the vehicle 1030. The vehicle rendering 1040 may also include colorings to indicate a relative distance to the ego. The interface 1020 may also display the curb 1050, which also uses colors to indicate a relative distance to the ego.

Among several advantages provided using the rendering method discussed herein is that an object can be rendered based on its occupied voxels and their corresponding signed distance field grid values. Therefore, the pole 1070 rendered within an interface 1060 (depicted in FIG. 10C) is rendered based on whether the voxels near the ego are occupied and not based on recognizing the pole and placing an arbitrary image of a pole in that location within the rendering.

The method and systems discussed herein can be executed in conjunction with and/or in a manner that supports various autonomous driving protocols. For instance, the high-fidelity occupancy network is discussed in FIGS. 6-10C (sometimes in conjunction with the occupancy network discussed with respect to FIGS. 1A-3B and the surface detection techniques discussed with respect to FIGS. 4A-5.

In some embodiments, the methods and systems discussed herein can be used in the development and implementation of an auto-park feature. Specifically, the methods discussed herein can be used for the detection of appropriate parking spots and/or navigation and control of the ego to park in the same. An auto-park feature using the methods and systems discussed herein differs from conventional assisted parking applications and software solutions because it allows users to select from multiple parking options rather than having the car automatically choose a parking spot. Additionally, the criteria used to suggest optimal parking spots based on factors like path smoothness and ease of maneuvering can be used to improve conventional auto-park features.

As used herein, a parking spot is not solely applicable to vehicles but can refer to any location where an object, whether autonomously navigated or controlled by another entity, can be stationed. Accordingly, “parking spot,” as used herein, also applies to robotic systems, drones, and other mobile entities. In some embodiments, parking spots can serve as designated zones for charging, storage, or temporary idling of egos. For example, a parking spot for a robot can be a designated charging dock where an autonomous warehouse robot returns after completing its assigned tasks. In another example, a parking spot may correspond to a reserved landing pad for delivery robots, providing a specific area where they can wait for pickup instructions or recharge between deliveries.

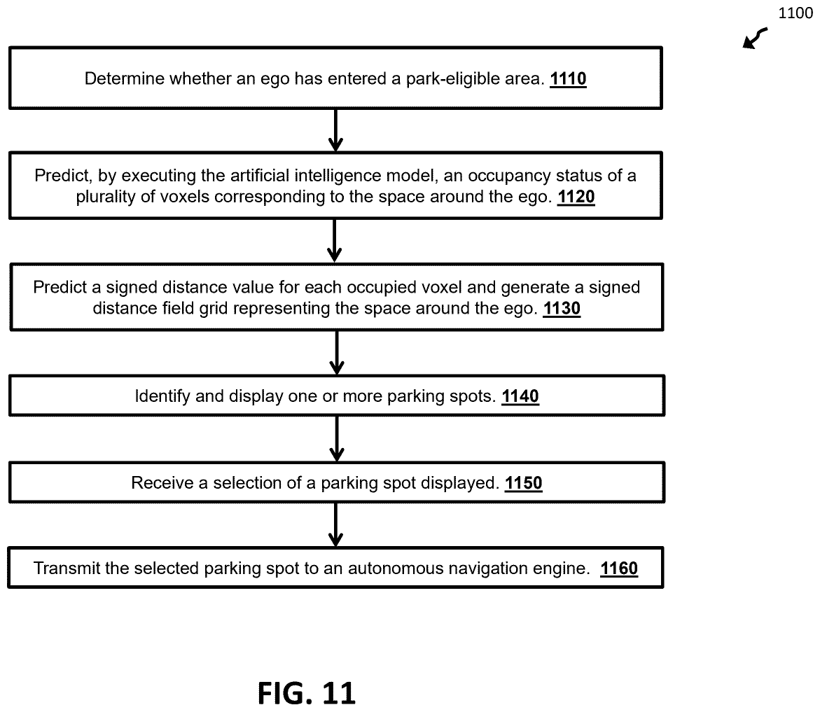

FIG. 11 illustrates a flow diagram of a method 1100 executed in an AI-enabled visual data analysis system, according to embodiments. The method 1100 may include steps 1110-1160. However, other embodiments may include additional or alternative steps or may omit one or more steps altogether. The method 1100 is described as being executed by an analytics server (e.g., a computer similar to the analytics server 110a). However, one or more steps of the method 1100 may be executed by any number of computing devices operating in the distributed computing system described in FIGS. 1A and 1B (e.g., a processor of the egos 140 and/or egos computing device 141). For instance, one or more computing devices may locally perform some or all of the steps described in FIG. 11. For instance, a chip placed within an ego may perform the method 1100.

At step 1110, the analytics server may determine whether an ego has entered a park-eligible area. As used here, a park-eligible area may include any area that can be used by the ego to park, such as street parking areas, parking lots, parking garages, and the like.

The analytics server may first determine whether the ego has entered a park-eligible area, such as a parking lot. The analytics server may use a variety of techniques to make this determination. For instance, the analytics server may first determine a speed associated with the ego. In some embodiments, if the ego is driving slowly, it suggests that the driver/ego may be seeking a parking spot. In another example, the analytics server may analyze the ego's location on the map (using various localization protocols). Using the location, the analytics server may determine whether the ego has entered a park-eligible area. For instance, parking lots may be pre-defined within a map.

In another example, the analytics server may analyze signs as the ego is driving. For instance, a sign indicating parking prices may indicate that the ego is entering a parking garage. In another example, the analytics server may use scene recognition algorithms to assess the space surrounding the ego, distinguishing between scenarios like approaching a toll booth or being in traffic while driving slowly versus entering a park-eligible area. In some embodiments, one or more AI models can be trained to recognize park-eligible areas using the position and movement (or lack thereof) of other vehicles around. By combining the techniques discussed herein, the analytics server system may accurately determine when the car is in a situation where parking is likely needed.

If the analytics server determines that the ego has entered a park-eligible area, the analytics server and/or a processor of the ego may use the AI model(s) discussed herein to reconstruct the ego's surrounding using the signed distance values discussed herein. For instance, the analytics server may execute the steps 1120-1130 and use the signed distances to identify and analyze the ego's surroundings. The analytics server may then (at 1140), use the rendering method discussed herein to display the ego's surrounding that may include one or more parking spots.

At step 1120, the analytics server may predict, by executing the artificial intelligence model, an occupancy status of a plurality of voxels corresponding to the space around the ego. Moreover, at step 1130, the analytics server may predict a signed distance value for each occupied voxel and generate a signed distance field grid representing the space around the ego.

Using the methods and systems discussed herein, the analytics server may use the AI models discussed herein to identify the surfaces (drivable or otherwise) surrounding the ego and determine the occupancy status of the voxels surrounding the ego.

When the analytics server determines that the ego has entered a park-eligible area, the analytics server may also utilize the high-fidelity occupancy AI model discussed herein to identify a more refined occupancy status of the voxels surrounding the ego.

At step 1140, the analytics server may identify and display one or more parking spots. The analytics server may use the voxel/surface recognition methods and techniques discussed herein to implement advanced algorithms and machine learning techniques to analyze visual data from the ego's camera to identify the available parking spots.

First, the analytics server may determine whether a space is occupied by another vehicle or any other object using the occupancy network. Using the methods and systems discussed herein, the analytics server may reconstruct an accurate representation of the ego's surroundings, including pertinent surfaces, other objects, vehicles, and paint lines. Then, for the unoccupied spaces, the analytics server may apply an AI model that can identify whether the unoccupied space is a parking space. In some embodiments, the analytics server may train an AI model using the camera feed of various egos driving around park-eligible areas where the appropriate parking spots are labeled within the training dataset. Using this training dataset, the AI model may learn how to distinguish parking spaces from other unoccupied spaces.

When the ego enters an area where parking spots are likely to be present (e.g., a park-eligible area, such as a parking lot or along a street), the analytics server may begin to feed the camera feed into the AI models discussed herein to determine available parking spots. Accordingly, the analytics server (utilizing the AI models) may then identify potential parking spots by detecting certain visual cues, such as painted lines on the ground or markings indicating designated parking areas. For instance, even if a parking spot is unoccupied, the AI model may detect that the parking spot includes painted voxels resembling a handicapped parking spot shape. As a result (if the ego is determined to be driven by a driver who is not handicapped), the AI model may not suggest that parking spot.

Some conventional parking spot detection mechanisms suffer from challenges because they use static thresholds that must be present when identifying a parking spot. For instance, some conventional methods only identify parking spots that are near curbs. Because the AI models discussed herein identify parking spots based on their training and not based on static thresholds and attributes, it is no longer limited in its ability to identify parking spots. For instance, a parking spot can be identified based on paint markings only even though the parking spot is not near a curb. For example, the AI model can identify parking spots in open-space parking lots, such as stadium settings. Moreover, this allows the AI model to identify where to park when the space is big enough to accommodate multiple cars. For instance, if the AI model encounters a space large enough to fit two cars, the AI model depends on paint or other markings to determine where to parking spot is. In some embodiments, the AI model may recommend two consecutive (side-by-side) parking spots. Moreover, some conventional systems provide assisted parking applications based on ultrasonics alone, which do not have the ability to detect painted lines. Therefore, the AI model discussed herein improves these conventional approaches.

In some embodiments, the AI models and/or the analytics server may also consider the existing signage to determine and/or identify a suitable parking spot. For instance, the AI model may identify a parking spot. However, the camera feed of the ego may include a “no parking” sign. As a result, the AI model determines that this parking spot (that otherwise would be suitable to park the ego) is not a suitable candidate. In some other embodiments, the sign may indicate a specific time frame for parking (e.g., “parking available on Monday-Friday from 7 AM to 8 PM”). Depending on a timestamp of the camera feed, the AI model may eliminate the parking spot from a list of candidate parking spots.

In some embodiments, a paint line color may be used to determine whether a parking spot is suitable. For instance, a parking spot may be unoccupied and suitable in size. However, the AI model may determine that the nearby curb has red paint. As a result, the AI model/analytics server may eliminate that parking spot from the list of candidate parking spots.

Using the technique, the analytics server can recognize different types of parking spaces, including parallel parking spots and standard perpendicular spaces.

In some embodiments, the analytics server may also consider other factors when identifying a parking spot, such as path smoothness or direction of the ego. For instance, a parking spot may not be suitable if it is located too far from the ego or the ego's path may require multiple turns.

At step 1150, the analytics server may receive a selection of a parking spot displayed. Once a parking spot is identified, the analytics server may display the parking spot(s) on a display associated with the ego, allowing the driver to select a preferred spot for parking. This process enables seamless integration of the auto-park feature with the high-fidelity occupancy network, providing accurate and reliable parking assistance to the driver.

At step 1160, the analytics server may transmit the selected parking spot to an autonomous navigation engine. Once the analytics server receives an indication from a driver of the ego as to which parking spot is desired, the analytics server may transmit the information (location or other indications of the selected parking spot to an autonomous driving engine where the autonomous driving engine can autonomously navigate the ego and park the ego within the selected parking spot.

The analytics server may continuously execute the AI models discussed herein even during the autonomous navigation of the ego. For instance, the AI models configured to perform voxelized occupancy detection and sign distance calculations discussed here can be executed during autonomous navigation to ensure that the ego can avoid any objects/obstacles.

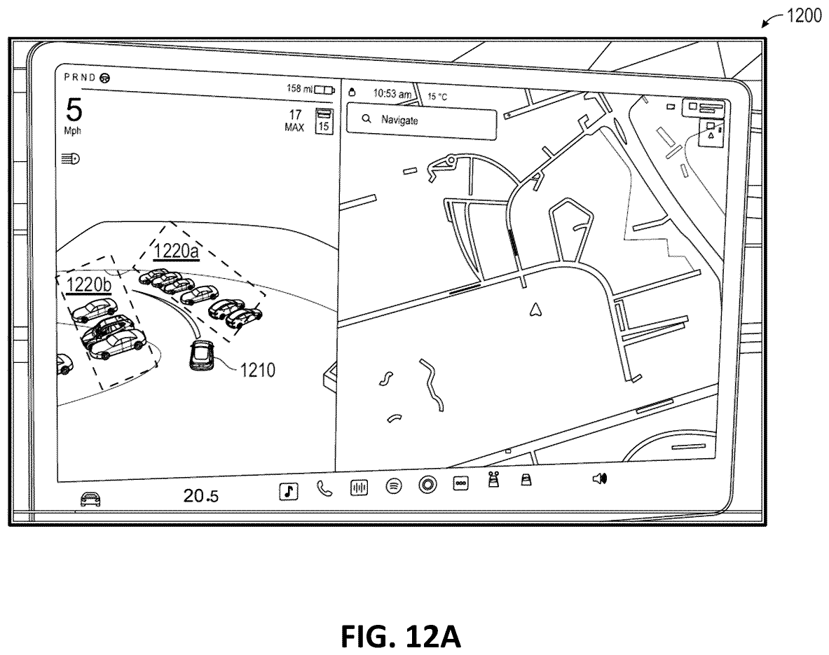

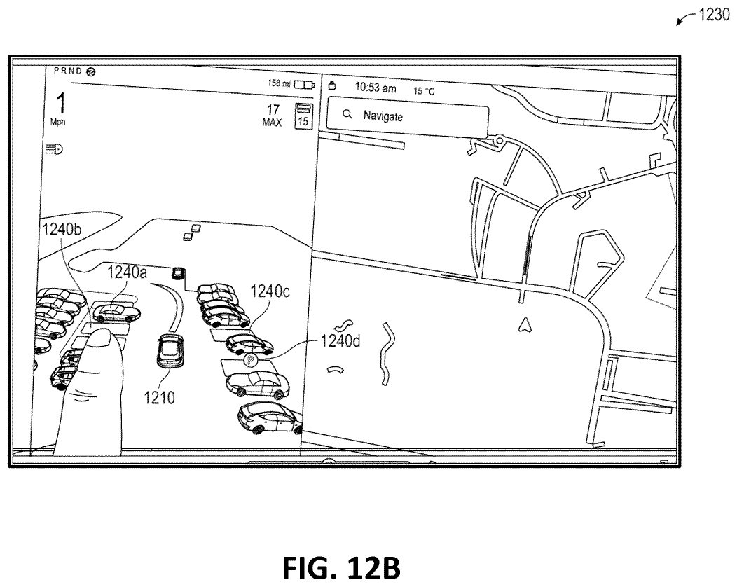

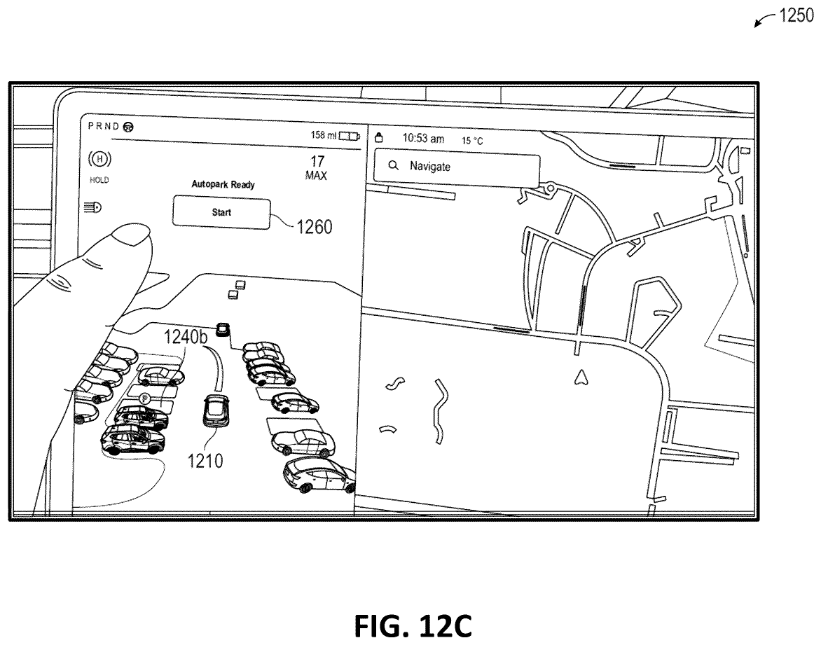

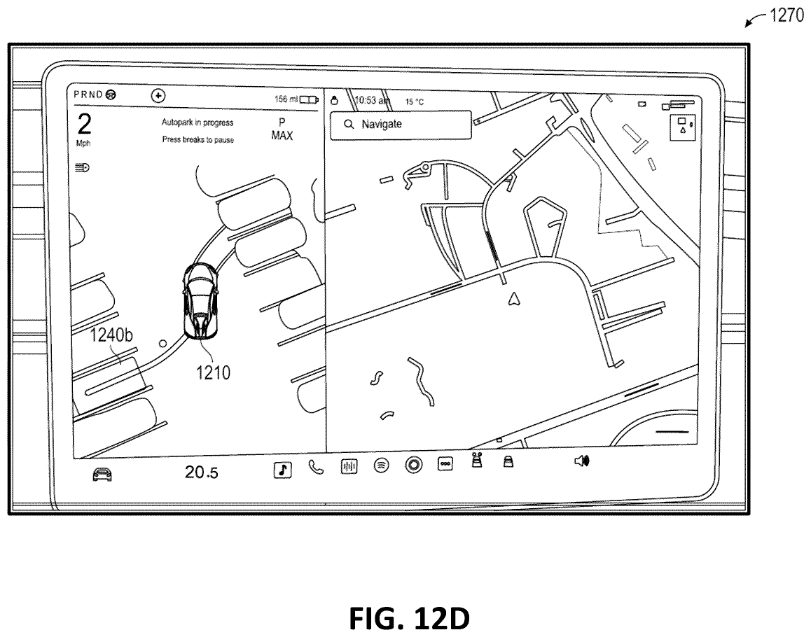

In a non-limiting example, the analytics server may use the methods and systems discussed herein in conjunction with an autonomous navigation engine to provide an assisted parking application (also referred to herein as auto-park or park assist), as depicted in FIGS. 12A-D. For instance, as depicted in FIG. 12A, an interface 1200 may display an ego 1210 as it nears an area where various other vehicles (1120a-b) are parked. Using the camera feed of the ego 1210, the analytics server may execute an AI model that identifies paint lines (associated with different parking spots) and the orientation of the other vehicle 1220a-b to determine that the ego 1210 has entered a parking lot.

When the analytic server determines that the ego 1210 has entered a parking lot, the analytic server feeds the camera feed of the ego 1210 to the AI models discussed herein to identify suitable parking spots. As depicted in the interface 1230, the analytics server identifies parking spots 1240a-d. Each identified parking spot may be displayed within the interface 1230 in a location that replicates its real-life location with respect to the ego 1210 and other vehicles. In some embodiments, the rendered representation of the identified parking spot may also include an indicator (“P” for parking), such as displayed on the parking spot 1240d. In some embodiments, the parking spots may be displayed in a different/distinct color than the objects or vehicles rendered within the interface 1230. For instance, if the space surrounding the ego is rendered in black and white, the identified parking spots may be displayed in blue or another color in order to highlight the identified parking spots to the driver.

In some embodiments, the analytics server may generate a suitability score for different identified parking spots. For instance, when the analytics server identifies multiple parking spots, the analytics server may evaluate each parking spot using one or more scoring schemas and using various factors to generate a suitability score for each parking spot. Non-limiting examples of factors may include a distance to the ego and/or a path attribute to the parking spot. For instance, a parking spot that is closer to the ego might have a higher score indicating that it is more desirable than a parking spot that is further away. In another configuration, a higher score may be assigned to a parking spot if the path to that parking spot includes fewer maneuvers (e.g., fewer turns and changes of direction needed, number of times that the ego changes from reverse to drive and/or drive to reverse). For example, as an ego travels through a parking lot, a closer spot that requires few maneuvers may be labeled as a preferred spot instead of a spot that is farther away or requires more maneuvers.

In some embodiments, the scoring may be customized by a driver of the ego. For instance, a driver may indicate a desire to park away from other vehicles. Therefore, the analytics server may consider whether any other vehicles are parked near a parking spot when generating the suitability score.

In some embodiments, the analytics server may revise a visual indicator of a parking spot in accordance with its suitability score. For instance, parking spots with higher suitability scores may be displayed more prominently (e.g., highlighted or using a color that is different than other parking spots). In some embodiments, a symbol (“P”) may be displayed on a parking spot that has the highest score indicating that the highlighted parking spot is preferred.

The analytics server may continuously update the suitability score as the ego navigates through the park-eligible area. For instance, while the suitability score of a parking spot may not be high when initially calculated, the ego might make a turn and the analytics server may re-calculate the suitability score for the same parking spot. During the second analysis, the analytics server assigns a higher score to the parking spot because the new path to the parking spot includes fewer turns, and the parking spot is now closer to the ego.

The interface displayed herein may also allow the driver to interact with the rendered identified parking spot. For instance, the interface 1250 may allow the user to touch the desired parking spot, in this example, the parking spot 1240. Once the desired parking spot has been selected, the rendering of the selected parking spot may be changed (e.g., change of color) to indicate that this particular spot has been selected.

Moreover, once a parking spot is selected, the interface 1250 may also display the interactive component 1260 configured to receive input from the driver regarding whether to park the ego within the selected parking spot. If the driver interacts with the interactive component 1260, the analytics server may transmit the location of the selected parking spot (e.g., parking spot 1240d) to an autonomous navigation engine along with an instruction to park the ego. The analytics server may then display the interface 1270, rendering real-time location and navigational information of the ego 1210 while the autonomous navigation engine parks the ego 1210 in the parking spot 1214d.

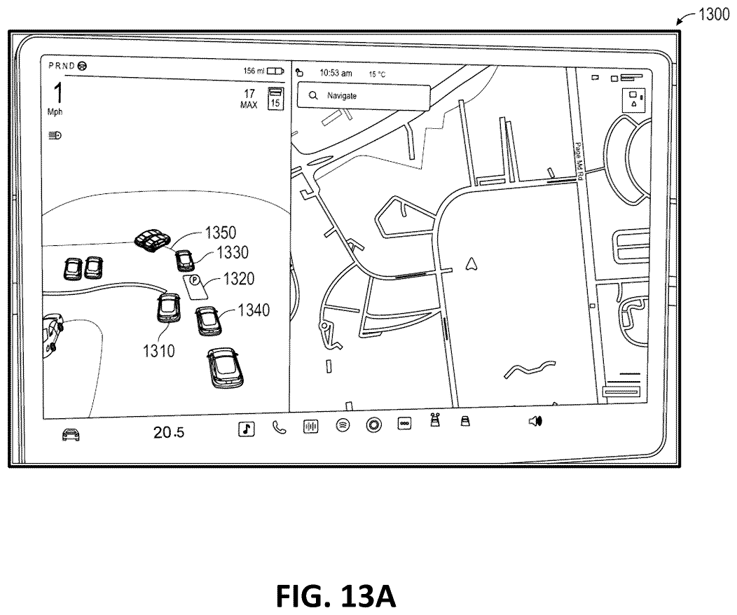

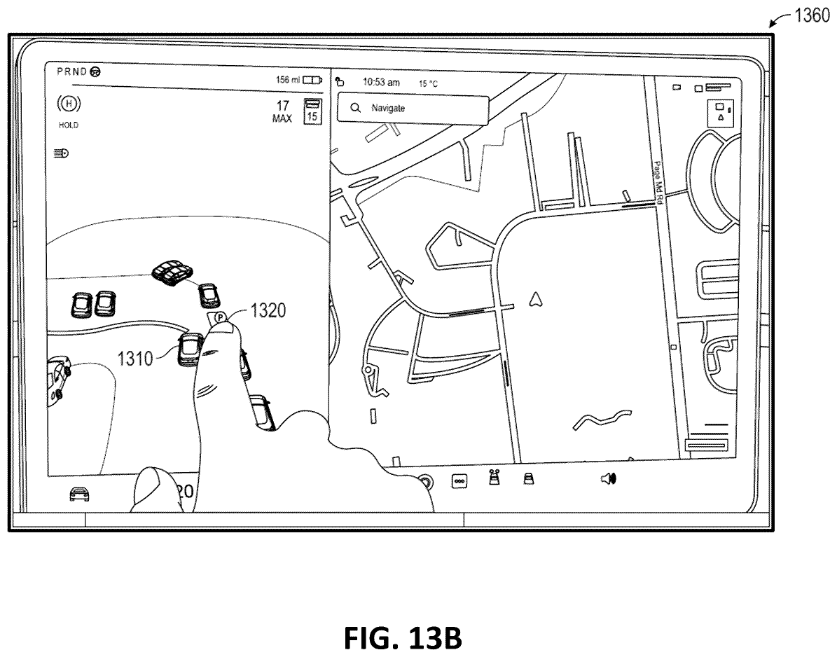

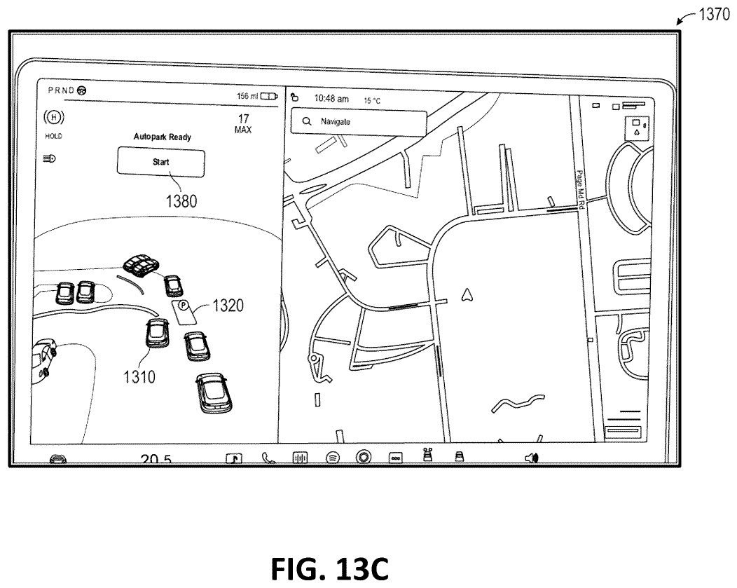

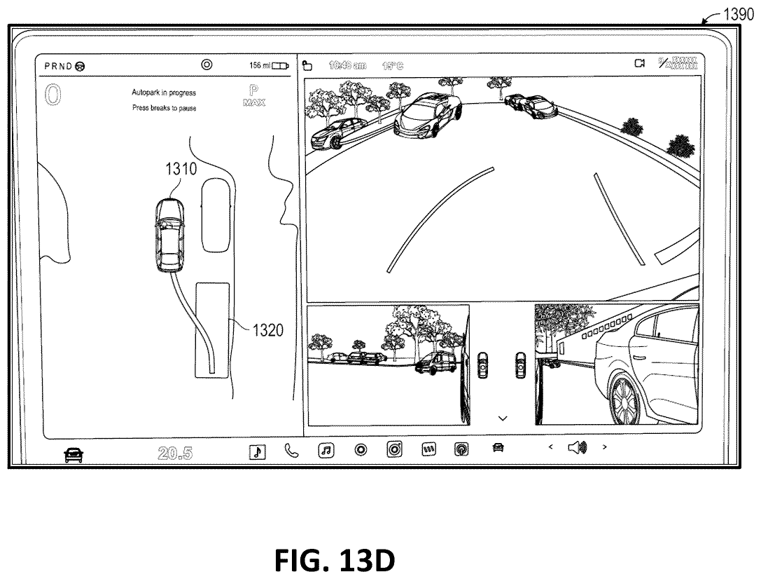

The methods and systems discussed herein can also apply to parallel parking or street parking, as depicted in FIGS. 13A-D. For instance, as depicted in the interface 1300, when an ego 1310 drives near an appropriate parking spot 1320 (between vehicles 1330 and 1340), the analytics server updates the interface 1300 to render the parking spot 1320 in a distinct color and further displays an indicator (“P”) to indicate the availability of the parking spot 1320.

The analytics server may continuously/periodically transmit a camera feed of the ego 1310 to one or more of the AI models discussed herein. Using the camera feed, the AI models may identify the parking spot 1320 and distinguish the parking spot 1320 from other empty spaces, such as the space 1350 (that may not be suitable for parking).

As discussed herein, the rendering of the parking spots may be interactive. For instance, as depicted in the interface 1360, the driver can interact with the parking spot 1320. When the analytics server receives the selection of the parking spot 1320, the analytics server may display the interface 1370 that highlights the parking spot 1320 (e.g., using a different color to indicate that the driver has selected the parking spot 1320). The interface 1370 may also include the interactive component 1380 to determine whether the driver is ready to park the ego 1310 in the spot 1320. After receiving the parking instructions from the driver, the analytics server instructs an autonomous navigation engine to park the ego 1310 to park in the parking spot 1320. As depicted (interface 1390), the analytic server may display a birds-eye view of the ego 1310 in conjunction with a real-time camera feed as the ego 1310 is being autonomously parked in the parking spot 1320.

Certain methods and systems described herein are presented in the context of a vehicle parking or navigating; however, all methods, systems, and embodiments disclosed herein are broadly applicable to any autonomous ego, including robots, vehicles, or any object capable of navigation and/or autonomous navigation. The AI-enabled visual data analysis techniques, voxel-based spatial awareness, signed distance field generation, and rendering methodologies can be adapted for various autonomous systems beyond vehicles, such as robotic navigation in warehouses, industrial automation, aerial drones, and other autonomous entities requiring precise environmental perception and maneuvering capabilities.

In an example application of the method 600 (depicted in FIG. 6) to the autonomous navigation of a robot in an interior office space, the AI-enabled visual data analysis system discussed herein can be used to assist a robotic entity, such as an autonomous delivery or cleaning robot, in navigating through an office environment while avoiding obstacles and identifying optimal paths. At step 610, the robot's onboard cameras may capture image data of its surrounding space, such as hallways, furniture, desks, and office equipment. This visual data may then be ingested by an artificial intelligence model trained to process environmental cues and construct an internal spatial map of the office environment. At step 620, the AI model may predict the occupancy status of various voxels within the robot's vicinity, determining which areas are occupied by objects such as walls, chairs, or people and which areas are navigable.

At step 630, the AI model may further refine spatial understanding by predicting signed distance values for each occupied voxel, generating a signed distance field grid that provides precise distance measurements to the nearest obstacles or objects. This may enable the robot to differentiate between tight spaces, open corridors, and obstructions that may require path adjustments. Using this information, the robot can dynamically update its internal map and adapt to changing conditions, such as an employee moving a chair or a door opening unexpectedly. At step 640, the system may execute a rendering protocol that translates the signed distance field grid into a high-fidelity 3D representation of the office space, allowing the robot's navigation engine to make real-time decisions based on an accurate environmental model. Though the rendering protocol may not be used by the robot itself or be displayed on the robot, the rendering protocol may be used for training the AI model(s) discussed herein and/or to present to a system administrator or a robot's owner.

In another example, applying the AI-driven techniques discussed in FIGS. 7-11, the robot can detect and differentiate between objects of interest, such as identifying an open conference room as an accessible path while recognizing cubicles and closed doors as non-navigable areas. The system can also utilize paint or floor markings, such as arrows or designated paths, to refine movement strategies, ensuring the robot adheres to predefined routes or operational constraints. Furthermore, by leveraging the continuous analysis of signed distance values, the robot can smoothly maneuver around obstacles, detect dynamically changing layouts, and optimize movement efficiency. The method 600 allows the robot to navigate autonomously without relying on traditional LiDAR or Radar sensors, making it suitable for compact, efficient robotic systems operating in any space, such as interior commercial office environments where GPS may not available.

The methods and systems discussed herein also apply to robotic devices in the context of parking. For instance, in an example application of method 1100 to the autonomous navigation of a robot in an interior office space, the AI-enabled visual data analysis system may enable the robot to locate and autonomously position itself in a designated docking or storage area within an office environment. At step 1110, the analytics server may determine whether the robot has entered a designated docking zone or workspace area suitable for temporary or permanent stationing, such as near a charging device or a place where the robot is stationed within an office. This can be achieved using visual cues, such as pre-defined markers on the floor, office layout recognition, or the robot's localization data within a mapped office environment. If the robot is operating in a shared workspace, the AI model can distinguish between areas intended for navigation (e.g., hallways, pathways) and designated docking areas (e.g., charging stations, storage locations) based on environmental features.

At step 1120, the robot's onboard cameras may capture real-time image data, which is processed by the AI model to predict the occupancy status of a plurality of voxels corresponding to its immediate surroundings. This ensures the robot identifies obstacles such as desks, chairs, office equipment, and employees moving within the space. At step 1130, the AI model may further refine its output by predicting signed distance values for each occupied voxel, generating a signed distance field grid representing the space around the robot. This enables precise spatial awareness, allowing the robot to measure distances between itself and nearby objects accurately. For instance, if multiple docking stations are available, the robot can evaluate spacing constraints and determine the most accessible option.

At step 1140, the analytics server may identify (and sometimes display for an administrator or an owner of the robot) one or more potential docking locations or resting spots for the robot. These locations may include a charging station, a designated storage area, or a maintenance zone. The system may leverage the high-fidelity occupancy data discussed herein to ensure the selected spot is unoccupied and suitable for docking. At step 1150, the robot receives confirmation regarding the selected docking spot, either autonomously based on predefined rules or through an interface where an operator (e.g., a human user/owner/administrator) can manually assign a preferred location. Once a docking location is selected, the analytics server may transmit the coordinates of the chosen spot to the robot's navigation engine at step 1160, initiating the autonomous movement sequence.

Applying the AI-driven techniques discussed in FIGS. 12-13D, the robot continuously updates its suitability assessment for available docking locations based on real-time conditions, such as detecting whether a previously unoccupied area has become obstructed or whether a power source is available at a given docking station. The system can also incorporate visual indicators, such as displaying different colors to denote the proximity of various docking locations relative to the robot's current position. Additionally, the AI model may evaluate environmental constraints such as narrow pathways or dynamically changing office layouts, adjusting the robot's path to ensure smooth and efficient movement. By leveraging high-fidelity visual processing and signed distance field calculations, the robot can autonomously navigate and dock with precision, optimizing its workspace utilization in an interior office environment.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or a machine-executable instruction may represent a procedure, function, subprogram, program, routine, subroutine, module, software package, class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means, including memory sharing, message passing, token passing, network transmission, etc.

The actual software code or specialized control hardware used to implement these systems and methods is not limited to the claimed features or this disclosure. Thus, the operation and behavior of the systems and methods were described without reference to the specific software code; it is understood that software and control hardware can be designed to implement the systems and methods based on the description herein.

When implemented in software, the functions may be stored as one or more instructions or code on a non-transitory, computer-readable, or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate the transfer of a computer program from one place to another. A non-transitory, processor-readable storage media may be any available media that can be accessed by a computer. By way of example, and not limitation, such non-transitory, processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that can be accessed by a computer or processor. Disk and disc, as used herein, include compact disc (CD), laser disc, optical disc, digital versatile disc (DVD), Blu-ray disc, and floppy disk, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory, processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What we claim is:

1. A method comprising:
determining, by at least one processor, whether an ego has entered a park-eligible area;
reconstructing, by the processor, a space surrounding the ego by:
executing an artificial intelligence model using one or more cameras of the ego to predict a signed distance value for at least one occupied voxel within the ego's surrounding, the signed distance value indicating a distance between the occupied voxel and a nearest occupied voxel;
identifying, by the processor, using the artificial intelligence model and the reconstructed space surrounding the ego, one or more parking spots within the park-eligible area; receiving, by the at least one processor, a selection of at least one parking spot; and
transmitting, by the at least one processor, data associated with the selected parking spot to an autonomous navigation engine along with an instruction to navigate the ego and park the ego in the selected parking spot.

2. The method of claim 1, wherein the at least one processor determines whether the ego has entered the park-eligible area based on at least one of a location of the ego matching a park-eligible location, identifying a sign within the space surrounding the ego indicating the park-eligible area, or a speed of the ego.

3. The method of claim 1, wherein the at least one processor determines whether the ego has entered the park-eligible area using a second artificial intelligence model that ingest data received from the one or more cameras of the ego.

4. The method of claim 3, wherein the second artificial intelligence model determines whether the ego has entered the park-eligible area based on an orientation of other vehicles within the park-eligible area.

5. The method of claim 1, wherein the one or more parking spots are selected based on a respective path attribute from the ego to the one or more parking spots.

6. The method of claim 1, wherein the one or more parking spots are selected based on paint line associated with each parking spot.

7. The method of claim 1, wherein the one or more parking spots are selected based on whether each parking spot includes a shaped group of painted voxels within its driving surface.

8. The method of claim 1, further comprising revising, by the at least one processor, a visual attribute of the selected parking spot.

9. The method of claim 1, wherein at least one parking spot requires parallel parking the ego.

10. The method of claim 1, further comprising:
displaying, by the at least one processor, a visual indicator for at least one identified parking spot.

11. A system comprising a computer-readable medium comprising non-transitory instructions that when executed cause at least one processor to:
determine whether an ego has entered a park-eligible area;
reconstruct a space surrounding the ego by:
executing an artificial intelligence model using one or more cameras of the ego to predict a signed distance value for at least one occupied voxel within the ego's surrounding, the signed distance value indicating a distance between the occupied voxel and a nearest occupied voxel;
identify using the artificial intelligence model and the reconstructed space surrounding the ego, one or more parking spots within the park-eligible area; receive a selection of at least one parking spot; and
transmit data associated with the selected parking spot to an autonomous navigation engine along with an instruction to navigate the ego and park the ego in the selected parking spot.

12. The system of claim 11, wherein the at least one processor determines whether the ego has entered the park-eligible area based on at least one of a location of the ego matching a park-eligible location, identifying a sign within the space surrounding the ego indicating the park-eligible area, or a speed of the ego.

13. The system of claim 11, wherein the at least one processor determines whether the ego has entered the park-eligible area using a second artificial intelligence model that ingest data received from the one or more cameras of the ego.

14. The system of claim 13, wherein the second artificial intelligence model determines whether the ego has entered the park-eligible area based on an orientation of other vehicles within the park-eligible area.

15. The system of claim 11, wherein the one or more parking spots are selected based on a respective path attribute from the ego to the one or more parking spots.

16. The system of claim 11, wherein the one or more parking spots are selected based on paint line associated with each parking spot.

17. The system of claim 11, wherein the one or more parking spots are selected based on whether each parking spot includes a shaped group of painted voxels within its driving surface.

18. A system comprising an ego comprising one or more cameras, the ego in communication with at least one processor that is configured to:
determine whether an ego has entered a park-eligible area;
reconstruct a space surrounding the ego by:
executing an artificial intelligence model using one or more cameras of the ego to predict a signed distance value for at least one occupied voxel within the ego's surrounding, the signed distance value indicating a distance between the occupied voxel and a nearest occupied voxel;
identify using the artificial intelligence model and the reconstructed space surrounding the ego, one or more parking spots within the park-eligible area; receive a selection of at least one parking spot; and
transmit data associated with the selected parking spot to an autonomous navigation engine along with an instruction to navigate the ego and park the ego in the selected parking spot.

19. The system of claim 18, wherein the at least one processor determines whether the ego has entered the park-eligible area based on at least one of a location of the ego matching a park-eligible location, identifying a sign within the space surrounding the ego indicating the park-eligible area, or a speed of the ego.

20. The system of claim 18, wherein the at least one processor determines whether the ego has entered the park-eligible area using a second artificial intelligence model that ingest data received from the one or more cameras of the ego.
